(19) United States
(12) Patent Application Publication
(10) Pub. No.: US 2012/0214591 A1
(43) Pub. Date: Aug. 23, 2012

(54) GAME DEVICE, STORAGE MEDIUM STORING GAME PROGRAM, GAME SYSTEM, AND GAME PROCESS METHOD

(75) Inventors: Jun ITO, Kyoto-shi (JP); Keizo Ohta, Kyoto-shi (JP)

(73) Assignee: NINTENDO CO., LTD., Kyoto (JP)

(21) Appl. No.: 13/343,459

(22) Filed: Jan. 4, 2012

(30) Foreign Application Priority Data
Feb. 22, 2011 (JP) 2011-036157

(51) Int. Cl. A63F 13/00

(52) U.S. Cl. 463/31

(57) ABSTRACT

An example game device obtains operation data, and controls an action of a character in a virtual space based on the operation data. A first virtual camera for generating a first game image is controlled in the virtual space in accordance with movement of the character. The game device specifies a position in the virtual space based on the operation data. A second virtual camera for generating a second game image is set at the specified position. The game device outputs the first game image to a first display device and the second game image to a second display device.

### CROSS REFERENCE TO RELATED APPLICATION

The disclosure of Japanese Patent Application No. 2011-036157 filed on Feb. 22, 2011, is incorporated herein by reference.

### FIELD

The present specification discloses a game device, a storage medium storing a game program, a game system, and a game process method for displaying images of a game space as viewed from a plurality of viewpoints.

### BACKGROUND AND SUMMARY

With a conventional game device, a control object (player character) is typically moved around using a controller device while displaying an image representing the game space as viewed from a viewpoint determined in accordance with the position of the player character. For example, a conventional game system displays a game image showing a player character, which is controlled by a controller device, as viewed in third-person perspective. In addition to game images in third-person perspective, game images in so-called “first-person perspective” are also common, which represent the game space as viewed from the viewpoint of the player character.

With conventional first-person perspective or third-person perspective game images, since the player cannot know the circumstances of a place that is a blind spot from the position of the player character, the player may not always be able to grasp the circumstances of a place in the game space that the player wishes to know. For example, with first-person perspective or third-person perspective game images, it may be difficult to handle an enemy character appearing from a place that is a blind spot from the player character, and it may be impossible to grasp the circumstances around the player character if the player character itself is moving while hiding behind an object. Thus, with conventional game images, it may be difficult to control the player character, and it is not always possible to present, to the player, game images that are easy to view.

For example, it may be possible to employ a method which enables the player to grasp the circumstances of a place that is a blind spot by switching game images from a game image representing the game space to a map image. With such a method, however, the progress of the game is discontinued by switching between the game images, and the player cannot play the game smoothly.

Therefore, the present specification discloses a game device, a game program, a game system and a game process method, with which it is possible to display game images showing the game space as viewed from a plurality of viewpoints, and it is possible to present, to the player, game images that are easier to view. The present specification discloses a game device, a storage medium storing a game program, a game system and a game process method, with which the game images are made easier to view, thereby enabling the provision of a game with contents that are more complicated than conventional games, thus providing higher playability.

(1)

An example game device described in this specification performs a game process based on operation data which is based on an operation performed on an operation unit. The game device includes an operation data obtaining unit, a character control unit, a first camera control unit, a first image generation unit, a position specification unit, a second camera control unit, a second image generation unit, and an image output unit. The operation data obtaining unit obtains the operation data. The character control unit controls an action of a character in a virtual space based on the operation data. The first camera control unit controls a first virtual camera in the virtual space in accordance with movement of the character. The first image generation unit generates a first game image based on the first virtual camera. The position specification unit specifies a position in the virtual space based on the operation data. The second camera control unit sets a second virtual camera at the position specified by the position specification unit. The second image generation unit generates a second game image based on the second virtual camera. The image output unit outputs the first game image to a first display device and the second game image to a second display device.

The “operation unit” is a concept including, in addition to the controller 5 and the terminal device 7 of the embodiment to be described below, any controller devices and input devices with which a player can perform game operations, such as a game controller, a remote controller, a keyboard, a mouse, and a portable device (buttons and sensors of a portable device).

The “game device” may be any information processing device capable of performing game processes to generate a game image based on the game processes. The game device may be a single-purpose information processing device for games, or a general-purpose information processing device such as an ordinary personal computer.

The “first camera control unit” may be any unit capable of controlling the position and/or the attitude of the first virtual camera in accordance with the movement of the character, and the control method may be any method. For example, the “first camera control unit” may control the first virtual camera so that the character is included in the viewing field range in order to generate a so-called “objective perspective” game image, or may control the first virtual camera so that the first virtual camera is arranged at a position at or near the character in order to generate a so-called “subjective perspective” game image.

The position specified by the “position specification unit” may be any position in the virtual space, and it may be a position included in the first game image or the second game image or a position included neither one of the game images.

The “first display device” and the “second display device” may each be a portable display device such as the terminal device 7 of the embodiment to be described below, or may be a non-portable display device such as the television 2. The “portable” means that the device has such a size that it can be held in hand and moved by the player, and the position thereof can be changed to any position by the player.

With the configuration (1) above, the first game image showing the game space as viewed from the viewpoint and/or the viewing direction which are determined in accordance with the movement of the character is displayed on the first display device, while the second game image showing the game space as viewed from the position specified by the player is displayed on the second display device. Then, it is possible to display different game images showing the game space as viewed from a plurality of viewpoints on different display devices. Since the position of the viewpoint in the second game image can be set by the player, a place that is a blind spot from a viewpoint determined in accordance with the position of the character can be made visible on the second game image, for example. Therefore, with the configuration (1) above, it is possible to present, to the player, game images that are easier to view. With the configuration (1) above, game images showing the game space as viewed from a plurality of viewpoints can be displayed simultaneously on two display devices, and the player can therefore play the game smoothly without having to switch between game screens.

With the configuration (1) above, since two display devices are used, it is possible to present game images that are easier to view as compared with a case where two game images are displayed by splitting the screen of a single display device in two. Particularly, where the screen of a single display device is split, if whether the second game image is displayed or not displayed is switched, the display area of the first game image changes by the switching, and the image becomes uneasy to view. In contrast, with the configuration (1) above, the display area of the first game image does not change whether the second game image is displayed or not displayed, and it is therefore possible to provide game images that are easier to view.

(2)

The second camera control unit may move the second virtual camera in accordance with the movement of the character when no position is specified by the position specification unit. In another configuration, the second camera control unit may move the second virtual camera as the first virtual camera is moved (i.e., so that the second virtual camera is moved in the same direction by the same amount as those of the first virtual camera) when no position is specified by the position specification unit.

The phrase “no position is specified” includes a state where it is before a position is specified and a state where after a position is specified, the specification is canceled.

With the configuration (2) above, when no position is specified, the second game image whose viewpoint position and/or viewing direction change in accordance with the movement of the character is displayed on the second display device. Then, in a state where no position is specified, the player does not have to perform the operation of moving the second virtual camera, separately from the operation of moving the character, thereby making game operations easier. When specifying the second virtual camera setting position, the player can check the position to be specified by looking at the second game image. Then, the player can perform a series of operations of specifying a position and checking an image of the game space as viewed from the specified position by looking only at the second game image (although the player is allowed to look at the first game image), and the player can therefore more easily perform the operations.

(3)

The first camera control unit may set the first virtual camera so that the character is included in a viewing field range. Then, the second camera control unit may set the second virtual camera at a position which is a viewpoint of the character when no position is specified by the position specification unit.

The “position which is a viewpoint of the character” is a concept including the position of the character and the vicinity thereof. That is, with the virtual camera arranged at such a position, a so-called “subjective perspective” game image may be generated.

With the configuration (3) above, two game images showing the virtual space from two different viewpoints which are positions determined in accordance with the character are displayed. Therefore, since the player can visually check the game space from two different viewpoints, the player can easily grasp the circumstances around the character, and it is thus possible to present game images that are easy to view. Particularly, if a position in the game space represented by the second game image can be specified as the second virtual camera setting position, the player can check the specific position to be specified, with the subjective perspective second game image, while checking the circumstances around the character with the objective perspective first game image, thus making the specifying operation easier.

(4)

The second camera control unit may further control a direction of the second virtual camera based on the operation data, independent of the movement of the character.

With the configuration (4) above, since the second camera control unit controls the direction of the second virtual camera, “independent of the movement of the character”, the direction of the second virtual camera is controlled based on the operation data even when the character is not moving. The second camera control unit may control the second virtual camera, independent of the movement of the character, only when no second virtual camera setting position is specified, only when a second virtual camera setting position is specified, or in both cases.

With the configuration (4) above, the player can change the viewing direction in addition to being able to specify the position of the second virtual camera. Therefore, it is possible to present second game images that are easier to view for the player.

(5)

The position specification unit may specify a direction in the virtual space based on the operation data, thereby specifying a position that is determined by the specified direction.

The “position that is determined by the specified direction” is not limited to a position along the straight line extending in the direction and does not have to be a point on the straight line as long as it is a position that is at least calculated based on the direction.

With the configuration (5) above, the player can specify the position of the second virtual camera by specifying a direction in the virtual space. Thus, it is possible to increase the level of difficulty in the operation of specifying the camera setting position, thereby improving the playability of the game. That is, with the configuration (5) above, the game presents the fun of deciding the position to set the virtual camera in the virtual space so as to gain an advantage in the game, and also the fun of being required of the control skills for setting the virtual camera at an intended position, thereby further improving the playability of the game.

(6)

The second camera control unit may change a direction of the second virtual camera in accordance with a change in the specified direction.

With the configuration (6) above, as long as the direction of the second virtual camera changes when the specified direction changes, the direction of the second virtual camera may or may not be equal to the specified direction.

With the configuration (6) above, since the direction of the second virtual camera changes in accordance with the specified direction, the player simultaneously perform the operation of changing the range of the game space represented by the second game image and the operation of changing the direction (position) to be specified. Therefore, the player can easily specify positions across a wide area of the game space, thus improving the ease of the position-specifying operation.

(7)

The position specification unit may calculate position coordinates on the first game image based on the operation data, thereby specifying a position in the virtual space corresponding to the position coordinates.

With the configuration (7) above, the player can specify the position at which the second virtual camera is placed by an operation of specifying a position on the first game image. Therefore, the player can perform both an operation on the character and an operation of specifying the position at which the second virtual camera is placed by looking at the first game image, thus improving the ease of these operations.

(8)

The position specification unit may calculate position coordinates on the second game image based on the operation data, thereby specifying a position in the virtual space corresponding to the position coordinates.

With the configuration (8) above, the player can specify the position at which the second virtual camera is placed by an operation of specifying a position on the second game image. Therefore, the player can perform a series of operations of specifying a position in the game space and checking an image of the game space as viewed from the specified position by looking at the second game image, thus improving the ease of the series of operations.

(9)

The operation data may include data representing a physical quantity for calculating an attitude of the operation unit. Then, the game device further includes an attitude calculation unit for calculating an attitude of the operation unit based on the physical quantity. The position specification unit calculates the specified position so that the specified position changes in accordance with a change in the attitude of the operation unit.

The “physical quantity for calculating an attitude” may be any quantity as long as the attitude of the operation unit can be calculated (estimated) based on the quantity. Therefore, the detection unit for detecting such a physical quantity may be an inertia sensor such as the gyrosensor and the acceleration sensor of the embodiment to be described below, or it may be a magnetic sensor or a camera. In a case in which the detection unit is a magnetic sensor, the azimuthal direction information detected by the magnetic sensor corresponds to the physical quantity. In a case in which the detection unit is a camera, a value regarding a captured image (e.g., pixel values) or a value obtained from the image (e.g., the position coordinates of a predetermined image-capturing object in the captured image) corresponds to the physical quantity.

With the configuration (9) above, the player can change the position to be specified by an intuitive and easy operation of changing the attitude of the operation unit.

(10)

The operation unit may include a gyrosensor. Then, the operation data includes, as the physical quantity, data representing an angular velocity detected by the gyrosensor.

With the configuration (10) above, the attitude of the operation unit can be accurately calculated by using the angular velocity detected by the gyrosensor.

(11)

The game device may further include an object control unit for moving a predetermined object in the virtual space to the specified position in response to a predetermined operation. Then, the second camera control unit moves the second virtual camera together with the predetermined object.

With the configuration (11) above, when the predetermined operation is performed, the predetermined object and the second virtual camera move to the specified position. Thus, it is possible to realize a game in which the viewpoint position of the second game image is moved by an operation of moving an object (e.g., a shooting operation). Since the player can visually check how the object moves and check the accurate position of the second virtual camera, it is possible to improve the controllability of the game.

(12)

The operation unit may be provided in a holdable housing separate from the first display device and the second display device.

With the configuration (12) above, two display devices may be arranged freely. Therefore, two display devices can be arranged side-by-side, for example, and then the player can look at the two display devices without substantially changing the viewing direction, thereby allowing the player to perform game operations comfortably.

(13)

The operation unit may be provided in the second display device.

With the configuration (13) above, a terminal device that includes a display device and a controller device as an integral unit is used, it is possible to reduce the number of components of the game system.

Other than the configurations (1) to (13) above, where the second virtual camera is set at a specified position, the second camera control unit may set the direction of the second virtual camera so that the character is included in the viewing field range.

Alternatively, when a predetermined condition is met, the first image generation unit may generate a first game image to be output to the first display device based on the second virtual camera, and the second image generation unit may generate a second game image to be output to the second display device based on the first virtual camera. The “predetermined condition” may be a game-related condition such as a condition regarding a parameter used in the game process or a condition regarding the progress of the game, or may be a condition related to the operation by the player (e.g., whether a predetermined operation has been performed by the player).

This specification also discloses a game system including the game device, the operation unit, and the second display device. Then, the second display device may be a portable display device. The image output unit may include an image transmitting unit for wirelessly transmitting the second game image to the second display device. Moreover, the second display device may include an image receiving unit for receiving the second game image, and a display unit for displaying the second game image received by the image receiving unit.

This specification also discloses a non-transitory computer-readable storage medium storing a game program capable of causing a computer of a game device (including an information processing device) to function as various units that are equivalent to the various units of the game device described above (the image output unit may not be included). This specification also discloses a game process method to be carried out by the game device or the game system described above.

With the game device, the non-transitory storage medium storing a game program, the game system, and the game process method described above, a first game image generated in accordance with the movement of the character and a second game image showing the game space as viewed from a position specified by a player are displayed, and it is therefore possible to display game images showing the game space as viewed from a plurality of viewpoints, thereby presenting, to the player, game images that are easier to view. Thus, even games of more complicated contents can be played, and games with higher playability can be provided.

These and other objects, features, aspects and advantages will become more apparent from the following detailed description when taken in conjunction with the accompanying drawings.

### BRIEF DESCRIPTION OF THE DRAWINGS

FIG. 1 is an external view of an example non-limiting game system 1;

FIG. 2 is a block diagram showing an internal configuration of an example non-limiting game device 3;

FIG. 3 is a perspective view showing an external configuration of an example non-limiting main controller 8;

FIG. 4 is another perspective view showing an external configuration of the example non-limiting main controller 8;

FIG. 5 is a diagram showing an internal configuration of the example non-limiting main controller 8;

FIG. 6 is another diagram showing an internal configuration of the example non-limiting main controller 8;

FIG. 7 is a perspective view showing an external configuration of an example non-limiting sub-controller 9;

FIG. 8 is a block diagram showing a configuration of an example non-limiting controller 5;

FIG. 9 is a diagram showing an external configuration of an example non-limiting terminal device 7;

FIG. 10 is a diagram showing the example non-limiting terminal device 7 being held by the user;

FIG. 11 is a block diagram showing an internal configuration of the example non-limiting terminal device 7;

FIG. 12 is a diagram showing an example television game image displayed on a television 2;

FIG. 13 is a diagram showing an example terminal game image displayed on the terminal device 7;

FIG. 14 is a diagram showing an example terminal game image after an arrow is launched;

FIG. 15 is a diagram showing various data used in game processes;

FIG. 16 is a main flow chart showing an example flow of a game process to be performed by the game device 3;

FIG. 17 is a flow chart showing an example detailed flow of a game control process (step S3) shown in FIG. 16;

FIG. 18 is a flow chart showing an example detailed flow of an attitude calculation process (step S11) shown in FIG. 17;

FIG. 19 is a flow chart showing an example detailed flow of a shooting process (step S14) shown in FIG. 17;

FIG. 20 is a diagram showing an example television game image in a variation of the embodiment above; and

FIG. 21 is a flow chart showing an example flow of a shooting process in the variation shown in FIG. 20.

### DETAILED DESCRIPTION OF NON-LIMITING EXAMPLE EMBODIMENTS

[1. Overall Configuration of the Game System]

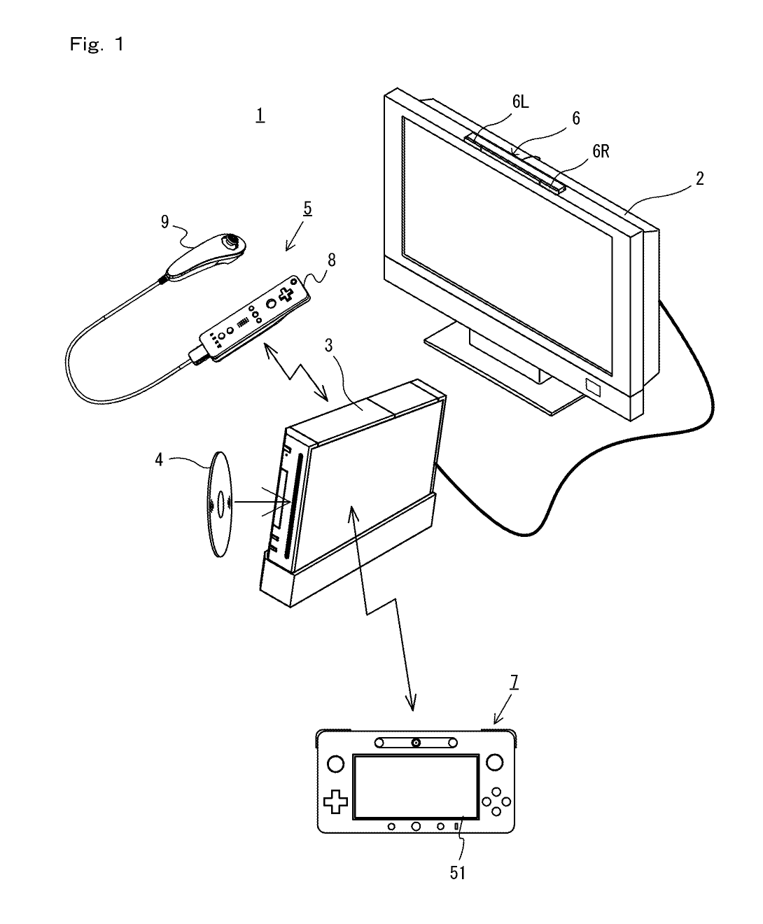

A game system 1 according to an example embodiment will now be described with reference to the drawings. FIG. 1 is an external view of the game system 1. In FIG. 1, a game system 1 includes a stationary display device (hereinafter referred to as a “television”) 2 such as a television receiver, a stationary game device 3, an optical disc 4, a controller 5, a marker device 6, and a terminal device 7. In the game system 1, a game device 3 performs game processes based on game operations performed using the controller 5, and game images obtained through the game processes are displayed on the television 2 and/or the terminal device 7.

In the game device 3, the optical disc 4 typifying an information storage medium used for the game device 3 in a replaceable manner is removably inserted. An information processing program (a game program, for example) to be executed by the game device 3 is stored in the optical disc 4. The game device 3 has, on the front surface thereof, an insertion opening for the optical disc 4. The game device 3 reads and executes the information processing program stored on the optical disc 4 which is inserted into the insertion opening, to perform the game process.

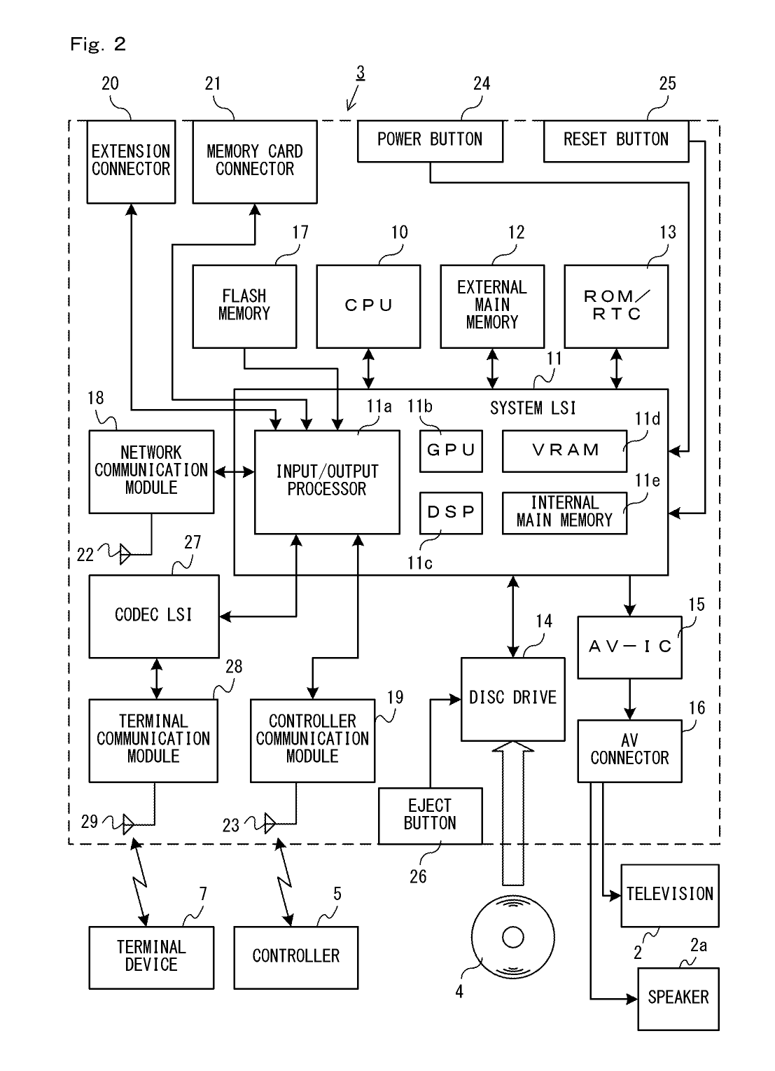

The television 2 is connected to the game device 3 by a connecting cord. Game images obtained as a result of the game processes performed by the game device 3 are displayed on the television 2. The television 2 includes a speaker 2a (see FIG. 2), and the speaker 2a outputs game sounds obtained as a result of the game process. In alternative example embodiments, the game device 3 and the stationary display device may be an integral unit. Also, the communication between the game device 3 and the television 2 may be wireless communication.

The marker device 6 is provided along the periphery of the screen (on the upper side of the screen in FIG. 1) of the television 2. The user (player) can perform game operations by moving the controller 5, the details of which will be described later, and the marker device 6 is used by the game device 3 for calculating the movement, position, attitude, etc., of the controller 5. The marker device 6 includes two markers 6R and 6L on opposite ends thereof. Specifically, the marker 6R (as well as the marker 6L) includes one or more infrared LEDs (Light Emitting Diodes), and emits an infrared light in a forward direction from the television 2. The marker device 6 is connected in a wired connection (or a wireless connection) to the game device 3, and the game device 3 is able to control the lighting of each infrared LED of the marker device 6. Note that the marker device 6 is of a transportable type so that the user can install the marker device 6 in any desired position. While FIG. 1 shows an example embodiment in which the marker device 6 is arranged on top of the television 2, the position and the direction of arranging the marker device 6 are not limited to this particular arrangement.

The controller 5 provides the game device 3 with operation data based on operations on the controller itself. In the present example embodiment, the controller 5 includes a main controller 8 and a sub-controller 9, and a sub-controller 9 is detachably attached to the main controller 8. The controller 5 and the game device 3 can wirelessly communicate with each other. In the present example embodiment, the wireless communication between the controller 5 and the game device 3 uses, for example, Bluetooth (Registered Trademark) technology. In other example embodiments, the controller 5 and the game device 3 may be connected by a wired connection. Furthermore, in FIG. 1, the game system 1 includes only one controller 5, but the game system 1 may include a plurality of controllers 5. That is, the game device 3 is capable of communicating with a plurality of controllers, so that by using a predetermined number of controllers at the same time, a plurality of people can play the game. The configuration of the controller 5 will be described in detail later.

The terminal device 7 is of a size that can be held by the user, so that the user can hold and move the terminal device 7 or can place the terminal device 7 in any desired position. As will be described in detail later, the terminal device 7 includes a liquid crystal display (LCD) 51, and input means (e.g., a touch panel 52 and a gyroscope 64 to be described later). The terminal device 7 can communicate with the game device 3 wirelessly (or wired). The terminal device 7 receives data for images generated by the game device 3 (e.g., game images) from the game device 3, and displays the images on the LCD 51. Note that in the present example embodiment, the LCD is used as the display of the terminal device 7, but the terminal device 7 may include any other display device, e.g., a display device utilizing electro luminescence (EL). Furthermore, the terminal device 7 transmits operation data based on operations thereon to the game device 3.

[2. Internal Configuration of the Game Device 3]

An internal configuration of the game device 3 will be described with reference to FIG. 2. FIG. 2 is a block diagram illustrating an internal configuration of the game device 3. The game device 3 includes a CPU (Central Processing Unit) 10, a system LSI 11, external main memory 12, a ROM/RTC 13, a disc drive 14, and an AV-IC 15.

The CPU 10 performs game processes by executing a game program stored, for example, on the optical disc 4, and functions as a game processor. The CPU 10 is connected to the system LSI 11. The external main memory 12, the ROM/RTC 13, the disc drive 14, and the AV-IC 15, as well as the CPU 10, are connected to the system LSI 11. The system LSI 11 performs processes for controlling data transmission between the respective components connected thereto, generating images to be displayed, obtaining data from an external device(s), and the like. The internal configuration of the system LSI 11 will be described below. The external main memory 12 is of a volatile type and stores a program such as a game program read from the optical disc 4, a game program read from flash memory 17, and various data. The external main memory 12 is used as a work area and a buffer area for the CPU 10. The ROM/RTC 13 includes a ROM (a so-called boot ROM) incorporating a boot program for the game device 3, and a clock circuit (RTC: Real Time Clock) for counting time. The disc drive 14 reads program data, texture data, and the like from the optical disc 4, and writes the read data into internal main memory 11e (to be described below) or the external main memory 12.

The system LSI 11 includes an input/output processor (I/O processor) 11a, a GPU (Graphics Processor Unit) 11b, a DSP (Digital Signal Processor) 11c, VRAM (Video RAM) 11d, and the internal main memory 11e. Although not shown in the figures, these components 11a to 11e are connected with each other through an internal bus.

The GPU 11b, acting as a part of a rendering unit, generates images in accordance with graphics commands (rendering commands) from the CPU 10. The VRAM lid stores data (data such as polygon data and texture data) to be used by the GPU 11b to execute the graphics commands. When images are generated, the GPU 11b generates image data using data stored in the VRAM 11d. Note that in the present example embodiment, the game device 3 generates both game images to be displayed on the television 2 and game images to be displayed on the terminal device 7. Hereinafter, the game images to be displayed on the television 2 are referred to as the “television game images” and the game images to be displayed on the terminal device 7 are referred to as the “terminal game images”.

The DSP 11c, functioning as an audio processor, generates sound data using sound data and sound waveform (e.g., tone quality) data stored in one or both of the internal main memory 11e and the external main memory 12. Note that in the present example embodiment, game sounds to be generated are classified into two types as in the case of the game images, one being outputted by the speaker of the television 2, the other being outputted by speakers of the terminal device 7. Hereinafter, in some cases, the game sounds to be outputted by the television 2 are referred to as “television game sounds”, and the game sounds to be outputted by the terminal device 7 are referred to as “terminal game sounds”.

Among the images and sounds generated by the game device 3 as described above, both image data and sound data to be outputted by the television 2 are read out by the AV-IC 15. The AV-IC 15 outputs the read-out image data to the television 2 via an AV connector 16, and outputs the read-out sound data to the speaker 2a provided in the television 2. Thus, images are displayed on the television 2, and sounds are outputted by the speaker 2a.

Furthermore, among the images and sounds generated by the game device 3, both image data and sound data to be outputted by the terminal device 7 are transmitted to the terminal device 7 by the input/output processor 11a, etc. The data transmission to the terminal device 7 by the input/output processor 11a, etc., will be described later.

The input/output processor 11a exchanges data with components connected thereto, and downloads data from an external device(s). The input/output processor 11a is connected to the flash memory 17, a network communication module 18, a controller communication module 19, an expansion connector 20, a memory card connector 21, and a codec LSI 27. Furthermore, an antenna 22 is connected to the network communication module 18. An antenna 23 is connected to the controller communication module 19. The codec LSI 27 is connected to a terminal communication module 28, and an antenna 29 is connected to the terminal communication module 28.

The game device 3 is capable of connecting to a network such as the Internet to communicate with external information processing devices (e.g., other game devices, various servers, and various information processing devices). Specifically, the input/output processor 11a can be connected to a network such as the Internet via the network communication module 18 and the antenna 22 to communicate with external information processing devices connected to the network. The input/output processor 11a regularly accesses the flash memory 17, and detects the presence or absence of any data to be transmitted to the network, and when detected, transmits the data to the network via the network communication module 18 and the antenna 22. Further, the input/output processor 11a receives data transmitted from the external information processing devices and data downloaded from a download server via the network, the antenna 22 and the network communication module 18, and stores the received data in the flash memory 17. The CPU 10 executes a game program so as to read data stored in the flash memory 17 and use the data, as appropriate, in the game program. The flash memory 17 may store game save data (e.g., game result data or unfinished game data) of a game played using the game device 3 in addition to data exchanged between the game device 3 and the external information processing devices. Moreover, the flash memory 17 may have a game program stored therein.

Furthermore, the game device 3 is capable of receiving operation data from the controller 5. Specifically, the input/output processor 11a receives operation data transmitted from the controller 5 via the antenna 23 and the controller communication module 19, and stores it (temporarily) in a buffer area of the internal main memory 11e or the external main memory 12.

Furthermore, the game device 3 is capable of exchanging data, for images, sound, etc., with the terminal device 7. When transmitting game images (terminal game images) to the terminal device 7, the input/output processor 11a outputs game image data generated by the GPU 11b to the codec LSI 27. The codec LSI 27 performs a predetermined compression process on the image data from the input/output processor 11a. The terminal communication module 28 wirelessly communicates with the terminal device 7. Accordingly, the image data compressed by the codec LSI 27 is transmitted by the terminal communication module 28 to the terminal device 7 via the antenna 29. In the present example embodiment, the image data transmitted from the game device 3 to the terminal device 7 is image data used in a game, and the playability of a game can be adversely influenced if there is a delay in the images displayed in the game. Therefore, delay may be avoided as much as possible in transmitting image data from the game device 3 to the terminal device 7. Therefore, in the present example embodiment, the codec LSI 27 compresses image data using a compression technique with high efficiency such as the H.264 standard, for example. Other compression techniques may be used, and image data may be transmitted uncompressed if the communication speed is sufficient. The terminal communication module 28 is, for example, a Wi-Fi certified communication module, and may perform wireless communication at high speed with the terminal device 7 using a MIMO (Multiple Input Multiple Output) technique employed in the IEEE 802.11n standard, for example, or may use other communication schemes.

Furthermore, in addition to the image data, the game device 3 also transmits sound data to the terminal device 7. Specifically, the input/output processor 11a outputs sound data generated by the DSP 11c to the terminal communication module 28 via the codec LSI 27. The codec LSI 27 performs a compression process on the sound data as it does on the image data. Any method can be employed for compressing the sound data, and such a method may use a high compression rate but may cause less sound degradation. Also, in another example embodiment, the sound data may be transmitted without compression. The terminal communication module 28 transmits compressed image and sound data to the terminal device 7 via the antenna 29.

Furthermore, in addition to the image and sound data, the game device 3 transmits various control data to the terminal device 7 where appropriate. The control data is data representing an instruction to control a component included in the terminal device 7, e.g., an instruction to control lighting of a marker unit (a marker unit 55 shown in FIG. 10) or an instruction to control shooting by a camera (a camera 56 shown in FIG. 10). The input/output processor 11a transmits the control data to the terminal device 7 in accordance with an instruction from the CPU 10. Note that in the present example embodiment, the codec LSI 27 does not perform a compression process on the control data, but in another example embodiment, a compression process may be performed. Note that the data to be transmitted from the game device 3 to the terminal device 7 may or may not be coded depending on the situation.

Furthermore, the game device 3 is capable of receiving various data from the terminal device 7. As will be described in detail later, in the present example embodiment, the terminal device 7 transmits operation data, image data, and sound data. The data transmitted by the terminal device 7 is received by the terminal communication module 28 via the antenna 29. Here, the image data and the sound data from the terminal device 7 have been subjected to the same compression process as performed on the image data and the sound data from the game device 3 to the terminal device 7. Accordingly, the image data and the sound data are transferred from the terminal communication module 28 to the codec LSI 27, and subjected to a decompression process by the codec LSI 27 before output to the input/output processor 11a. On the other hand, the operation data from the terminal device 7 is smaller in size than the image data or the sound data and therefore is not always subjected to a compression process. Moreover, the operation data may or may not be coded depending on the situation. Accordingly, after being received by the terminal communication module 28, the operation data is outputted to the input/output processor 11a via the codec LSI 27. The input/output processor 11a stores the data received from the terminal device 7 (temporarily) in a buffer area of the internal main memory 11e or the external main memory 12.

Furthermore, the game device 3 can be connected to other devices or external storage media. Specifically, the input/output processor 11a is connected to the expansion connector 20 and the memory card connector 21. The expansion connector 20 is a connector for an interface, such as a USB or SCSI interface. The expansion connector 20 can receive a medium such as an external storage medium, a peripheral device such as another controller, or a wired communication connector which enables communication with a network in place of the network communication module 18. The memory card connector 21 is a connector for connecting thereto an external storage medium such as a memory card (which may be of a proprietary or standard format, such as SD, miniSD, microSD, Compact Flash, etc.). For example, the input/output processor 11a can access an external storage medium via the expansion connector 20 or the memory card connector 21 to store data in the external storage medium or read data from the external storage medium.

The game device 3 includes a power button 24, a reset button 25, and an eject button 26. The power button 24 and the reset button 25 are connected to the system LSI 11. When the power button 24 is on, power is supplied from an external power source to the components of the game device 3 via an AC adaptor (not shown). When the reset button 25 is pressed, the system LSI 11 reboots a boot program of the game device 3. The eject button 26 is connected to the disc drive 14. When the eject button 26 is pressed, the optical disc 4 is ejected from the disc drive 14.

In other example embodiments, some of the components of the game device 3 may be provided as extension devices separate from the game device 3. In this case, an extension device may be connected to the game device 3 via the expansion connector 20, for example. Specifically, an extension device may include components as described above, e.g., a codec LSI 27, a terminal communication module 28, and an antenna 29, and can be attached to/detached from the expansion connector 20. Thus, by connecting the extension device to a game device which does not include the above components, the game device can communicate with the terminal device 7.

[3. Configuration of the Controller 5]

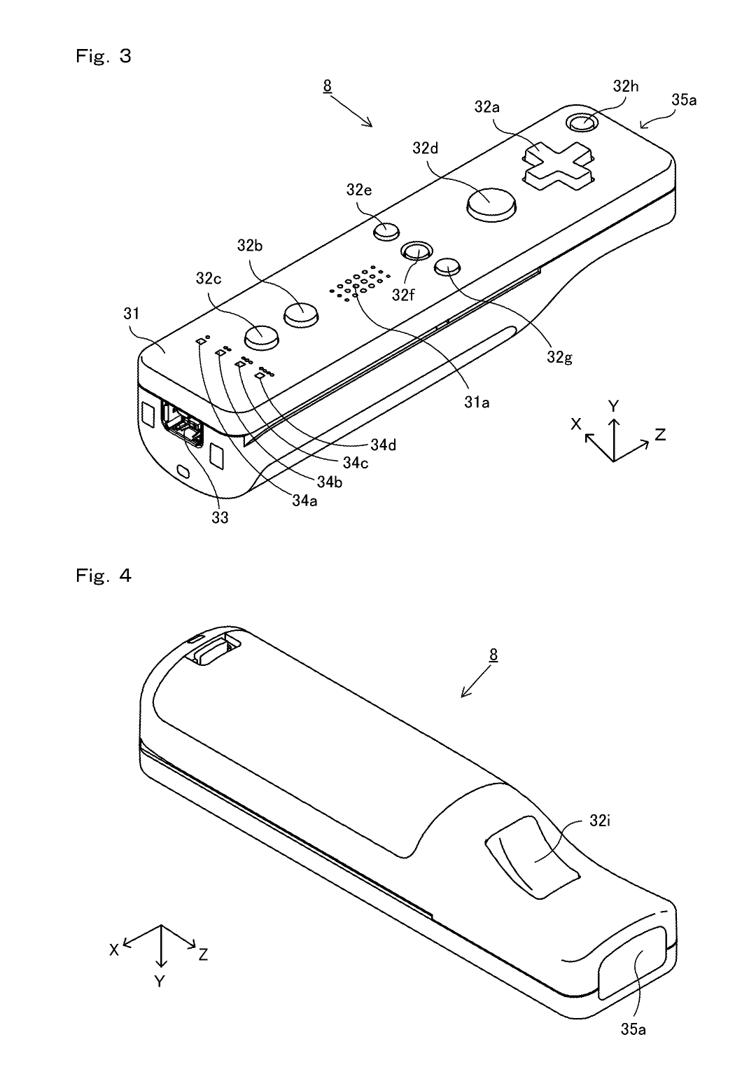

Next, with reference to FIGS. 3 to 7, the controller 5 will be described. As described above, the controller 5 includes the main controller 8 and the sub-controller 9. FIG. 3 is a perspective view illustrating an external configuration of the main controller 8. FIG. 4 is a perspective view illustrating an external configuration of the main controller 8. The perspective view of FIG. 3 shows the main controller 8 as viewed from the top rear side thereof, and the perspective view of FIG. 4 shows the main controller 8 as viewed from the bottom front side thereof.

As shown in FIG. 3 and FIG. 4, the main controller 8 has a housing 31 formed by, for example, plastic molding. The housing 31 has a generally parallelepiped shape extending in a longitudinal direction from front to rear (Z-axis direction shown in FIG. 3), and as a whole is sized to be held by one hand of an adult or even a child. The user can perform game operations by pressing buttons provided on the main controller 8, and moving the main controller 8 to change the position and the attitude (tilt) thereof.

The housing 31 has a plurality of operation buttons. As shown in FIG. 3, on the top surface of the housing 31, a cross button 32a, a first button 32b, a second button 32c, an A button 32d, a minus button 32e, a home button 32f, a plus button 32g, and a power button 32h are provided. In the present example embodiment, the top surface of the housing 31 on which the buttons 32a to 32h are provided may be referred to as a “button surface”. On the other hand, as shown in FIG. 4, a recessed portion is formed on the bottom surface of the housing 31, and a B button 32i is provided on a rear slope surface of the recessed portion. The operation buttons 32a to 32i are appropriately assigned their respective functions in accordance with the information processing program executed by the game device 3. Further, the power button 32h is intended to remotely turn ON/OFF the game device 3. The home button 32f and the power button 32h each have the top surface thereof recessed below the top surface of the housing 31. Therefore, the home button 32f and the power button 32h are prevented from being inadvertently pressed by the user.

On the rear surface of the housing 31, the connector 33 is provided. The connector 33 is used for connecting the main controller 8 to another device (e.g., the sub-controller 9 or another sensor unit). Both sides of the connector 33 on the rear surface of the housing 31 have a fastening hole 33a for preventing easy inadvertent disengagement of another device as described above.

In the rear-side portion of the top surface of the housing 31, a plurality (four in FIG. 3) of LEDs 34a, 34b, 34c, and 34d are provided. The controller 5 (the main controller 8) is assigned a controller type (number) so as to be distinguishable from another controller. The LEDs 34a, 34b, 34c, and 34d are each used for informing the user of the controller type which is currently being set for the controller 5 being used, and for informing the user of remaining battery power of the controller 5, for example. Specifically, when a game operation is performed using the controller 5, one of the LEDs 34a, 34b, 34c, and 34d corresponding to the controller type is lit up.

The main controller 8 has an image-capturing/processing unit 35 (FIG. 6), and a light incident surface 35a through which a light is incident on the image-capturing/processing unit 35 is provided on the front surface of the housing 31, as shown in FIG. 4. The light incident surface 35a is made of a material transmitting therethrough at least infrared light outputted by the markers 6R and 6L.

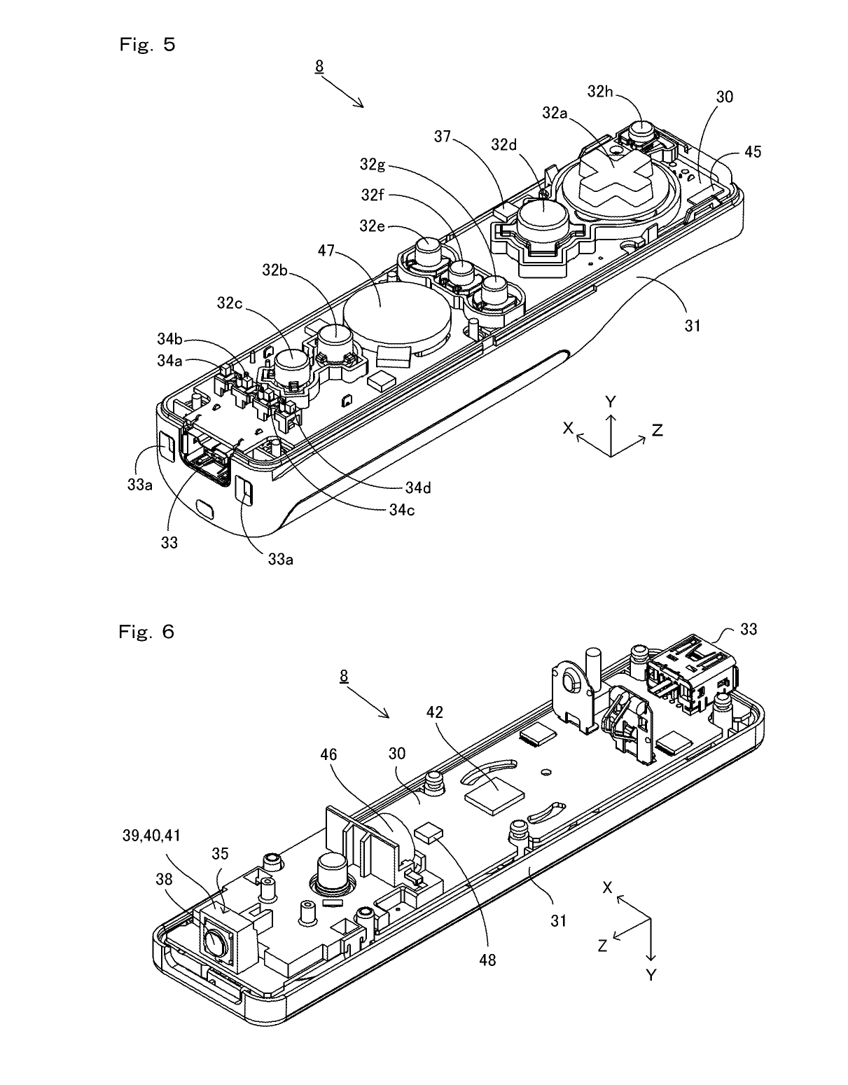

On the top surface of the housing 31, sound holes 31a for externally outputting a sound from a speaker 47 (shown in FIG. 5) incorporated in the main controller 8 is provided between the first button 32b and the home button 32f.

Next, with reference to FIGS. 5 and 6, an internal configuration of the main controller 8 will be described. FIGS. 5 and 6 are diagrams illustrating the internal configuration of the main controller 8. FIG. 5 is a perspective view illustrating a state where an upper casing (a part of the housing 31) of the main controller 8 is removed. FIG. 6 is a perspective view illustrating a state where a lower casing (a part of the housing 31) of the main controller 8 is removed. The perspective view of FIG. 6 shows a substrate 30 of FIG. 5 as viewed from the reverse side.

As shown in FIG. 5, the substrate 30 is fixed inside the housing 31, and on a top main surface of the substrate 30, the operation buttons 32a to 32h, the LEDs 34a, 34b, 34c, and 34d, an acceleration sensor 37, an antenna 45, the speaker 47, and the like are provided. These elements are connected to a microcomputer 42 (see FIG. 6) via lines (not shown) formed on the substrate 30 and the like. In the present example embodiment, an acceleration sensor 37 is provided on a position offset from the center of the main controller 8 with respect to the X-axis direction. Thus, calculation of the movement of the main controller 8 being rotated about the Z-axis may be facilitated. Further, the acceleration sensor 37 is provided anterior to the center of the main controller 8 with respect to the longitudinal direction (Z-axis direction). Further, a wireless module 44 (see FIG. 6) and the antenna 45 allow the controller 5 (the main controller 8) to act as a wireless controller.

On the other hand, as shown in FIG. 6, at a front edge of a bottom main surface of the substrate 30, the image-capturing/processing unit 35 is provided. The image-capturing/processing unit 35 includes an infrared filter 38, a lens 39, an image-capturing element 40 and an image processing circuit 41 located in order, respectively, from the front of the main controller 8. These components 38 to 41 are attached on the bottom main surface of the substrate 30.

On the bottom main surface of the substrate 30, the microcomputer 42 and a vibrator 46 are provided. The vibrator 46 is, for example, a vibration motor or a solenoid, and is connected to the microcomputer 42 via lines formed on the substrate 30 or the like. The main controller 8 is vibrated by actuation of the vibrator 46 based on a command from the microcomputer 42. Therefore, the vibration is conveyed to the user's hand holding the main controller 8, and thus a so-called vibration-feedback game is realized. In the present example embodiment, the vibrator 46 is disposed slightly toward the front of the housing 31. That is, the vibrator 46 is positioned offset from the center toward the end of the main controller 8, and therefore the vibration of the vibrator 46 can lead to enhancement of the vibration of the entire main controller 8. Further, the connector 33 is provided at the rear edge of the bottom main surface of the substrate 30. In addition to the components shown in FIGS. 5 and 6, the main controller 8 includes a quartz oscillator for generating a reference clock of the microcomputer 42, an amplifier for outputting a sound signal to the speaker 47, and the like.

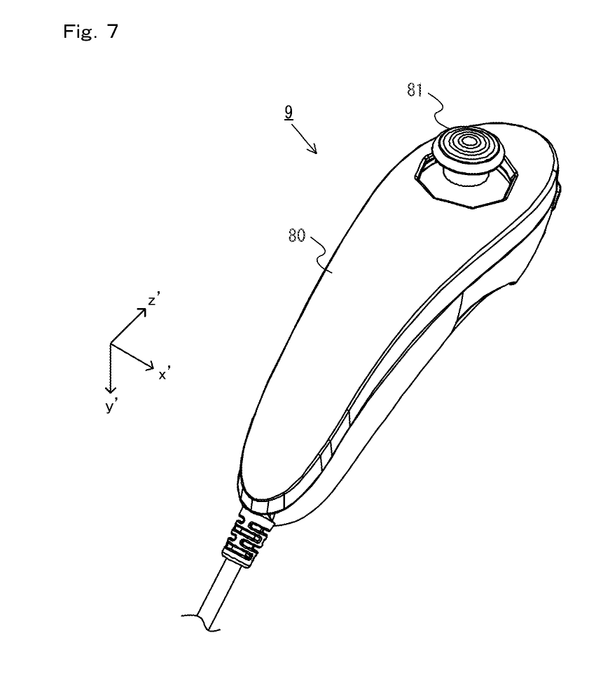

FIG. 7 is a perspective view illustrating an external configuration of the sub-controller 9. The sub-controller 9 includes a housing 80 formed by, for example, plastic molding. As with the main controller 8, the housing 80 is sized as a whole to be held by a hand of an adult or a child. In the case of using the sub-controller 9 also, the player can perform game operations by operating buttons and sticks and changing the position and the direction of the sub-controller.

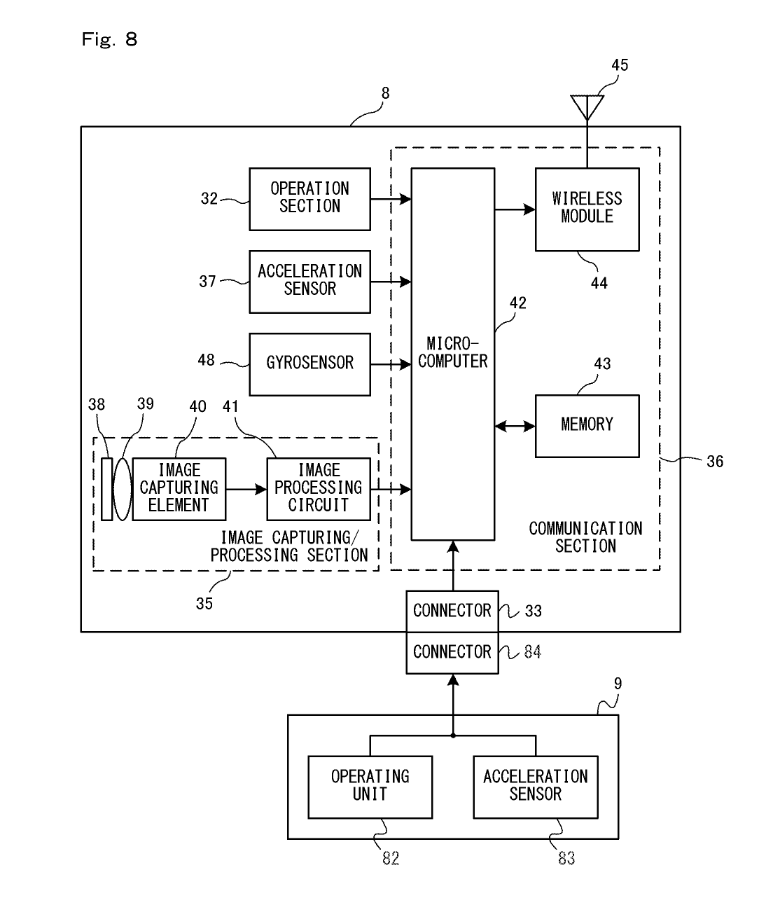

As shown in FIG. 7, the housing 80 has an analog joy stick 81 provided at the tip side (the z′-axis positive direction side) on the upper surface (the surface on the y′-axis negative direction side). Although not shown, the tip of the housing 80 has a surface slightly inclined backward, and a C button and a Z button are provided at the tip surface so as to be arranged vertically (the y-axis direction shown in FIG. 3). The analog joy stick 81 and these buttons (the C button and the Z button) are appropriately assigned their functions in accordance with game programs to be executed by the game device 3. Note that in some cases, an analog joystick 81 and these buttons may be collectively referred to as an “operating unit 82 (see FIG. 8)”.

Although not shown in FIG. 7, the sub-controller 9 also includes an acceleration sensor (acceleration sensor 83 shown in FIG. 8) inside the housing 80. In the present example embodiment, an acceleration sensor 83 is of the same type as the acceleration sensor 37 of the main controller 8. However, the acceleration sensor 83 may be of a different type from the acceleration sensor 37 and may detect acceleration about, for example, a predetermined one axis or two axes.

Furthermore, as shown in FIG. 7, the housing 80 is connected at the rear to one end of a cable. Although not shown in FIG. 7, the other end of the cable is attached to a connector (connector 84 shown in FIG. 8). The connector can be attached to the connector 33 of the main controller 8. That is, by attaching the connector 33 to the connector 84, the main controller 8 is attached to the sub-controller 9.

Note that FIGS. 3 to 7 only show examples of the shapes of the main controller 8 and the sub-controller 9, the shape of each operation button, the number and the positions of acceleration sensors and vibrators, and so on, and other shapes, numbers, and positions may be employed. Further, although in the present example embodiment, the imaging direction of the image-capturing means of the main controller 8 is the Z-axis positive direction, the imaging direction may be any direction. That is, the image-capturing/processing unit 35 (the light incident surface 35a through which a light is incident on the image-capturing/processing unit 35) of the controller 5 may not necessarily be provided on the front surface of the housing 31, but may be provided on any other surface on which a light can be received from the outside of the housing 31.

FIG. 8 is a block diagram illustrating a configuration of the controller 5. As shown in FIG. 8, the main controller 8 includes an operating unit 32 (the operation buttons 32a to 32i), the image-capturing/processing unit 35, a communication unit 36, the acceleration sensor 37, and a gyroscope 48. The sub-controller 9 includes an operating unit 82 and an acceleration sensor 83. The controller 5 transmits, as operation data, data representing the content of an operation performed on the controller 5 itself, to the game device 3. Note that hereinafter, in some cases, operation data transmitted by the controller 5 is referred to as “controller operation data”, and operation data transmitted by the terminal device 7 is referred to as “terminal operation data”.

The operating unit 32 includes the operation buttons 32a to 32i described above, and outputs, to the microcomputer 42 of the communication unit 36, operation button data indicating an input state (that is, whether or not each operation button 32a to 32i is pressed) of each operation button 32a to 32i.

The image-capturing/processing unit 35 is a system for analyzing image data taken by the image-capturing means and calculating, for example, the centroid and the size of an area having a high brightness in the image data. The image-capturing/processing unit 35 has a maximum sampling period of, for example, about 200 frames/sec., and therefore can trace and analyze even a relatively fast motion of the controller 5.

The image-capturing/processing unit 35 includes the infrared filter 38, the lens 39, the image-capturing element 40 and the image processing circuit 41. The infrared filter 38 transmits therethrough only infrared light included in the light incident on the front surface of the controller 5. The lens 39 collects the infrared light transmitted through the infrared filter 38 so as to be incident on the image-capturing element 40. The image-capturing element 40 is a solid-state imaging device such as, for example, a CMOS sensor or a CCD sensor, which receives the infrared light collected by the lens 39, and outputs an image signal. The marker unit 55 of the terminal device 7 and the marker device 6, which are subjects to be imaged, include markers for outputting infrared light. Therefore, the infrared filter 38 enables the image-capturing element 40 to receive only the infrared light transmitted through the infrared filter 38 and generate image data, so that an image of each subject to be imaged (the marker unit 55 and/or the marker device 6) can be taken with enhanced accuracy. Hereinafter, the image taken by the image-capturing element 40 is referred to as a captured image. The image data generated by the image-capturing element 40 is processed by the image processing circuit 41. The image processing circuit 41 calculates, in the captured image, the positions of subjects to be imaged. The image processing circuit 41 outputs data representing coordinate points of the calculated positions, to the microcomputer 42 of the communication unit 36. The data representing the coordinate points is transmitted as operation data to the game device 3 by the microcomputer 42. Hereinafter, the coordinate points are referred to as “marker coordinate points”. The marker coordinate point changes depending on the attitude (angle of tilt) and/or the position of the controller 5 itself, and therefore the game device 3 is allowed to calculate the attitude and the position of the controller 5 using the marker coordinate point.

In another example embodiment, the controller 5 may not necessarily include the image processing circuit 41, and the controller 5 may transmit the captured image as it is to the game device 3. At this time, the game device 3 may have a circuit or a program, having the same function as the image processing circuit 41, for calculating the marker coordinate point.

The acceleration sensor 37 detects accelerations (including a gravitational acceleration) of the controller 5, that is, force (including gravity) applied to the controller 5. The acceleration sensor 37 detects a value of an acceleration (linear acceleration) applied to a detection unit of the acceleration sensor 37 in the straight line direction along the sensing axis direction, among all accelerations applied to a detection unit of the acceleration sensor 37. For example, a multiaxial acceleration sensor having two or more axes detects an acceleration of a component for each axis, as the acceleration applied to the detection unit of the acceleration sensor. The acceleration sensor 37 is, for example, a capacitive MEMS (Micro-Electro Mechanical System) acceleration sensor. However, another type of acceleration sensor may be used.

In the present example embodiment, the acceleration sensor 37 detects a linear acceleration in each of three axis directions, i.e., the up/down direction (Y-axis direction shown in FIG. 3), the left/right direction (the X-axis direction shown in FIG. 3), and the forward/backward direction (the Z-axis direction shown in FIG. 3), relative to the controller 5. The acceleration sensor 37 detects acceleration in the straight line direction along each axis, and an output from the acceleration sensor 37 represents a value of the linear acceleration for each of the three axes. In other words, the detected acceleration is represented as a three-dimensional vector in an XYZ-coordinate system (controller coordinate system) defined relative to the controller 5.

Data (acceleration data) representing the acceleration detected by the acceleration sensor 37 is outputted to the communication unit 36. The acceleration detected by the acceleration sensor 37 changes depending on the attitude (angle of tilt) and the movement of the controller 5, and therefore the game device 3 is allowed to calculate the attitude and the movement of the controller 5 using the obtained acceleration data. In the present example embodiment, the game device 3 calculates the attitude, angle of tilt, etc., of the controller 5 based on the obtained acceleration data.

When a computer such as a processor (e.g., the CPU 10) of the game device 3 or a processor (e.g., the microcomputer 42) of the controller 5 processes an acceleration signal outputted by the acceleration sensor 37 (or similarly from an acceleration sensor 63 to be described later), additional information relating to the controller 5 can be inferred or calculated (determined), as one skilled in the art will readily understand from the description herein. For example, in the case where the computer performs processing on the premise that the controller 5 including the acceleration sensor 37 is in static state (that is, in the case where processing is performed on the premise that the acceleration to be detected by the acceleration sensor includes only the gravitational acceleration), when the controller 5 is actually in static state, it is possible to determine whether or not, or how much the controller 5 tilts relative to the direction of gravity, based on the acceleration having been detected. Specifically, when the state where the detection axis of the acceleration sensor 37 faces vertically downward is set as a reference, whether or not the controller 5 tilts relative to the reference can be determined based on whether or not 1G (gravitational acceleration) is applied to the detection axis, and the degree to which the controller 5 tilts relative to the reference can be determined based on the magnitude of the gravitational acceleration. Further, the multiaxial acceleration sensor 37 processes the acceleration signals having been detected for the respective axes so as to more specifically determine the degree to which the controller 5 tilts relative to the direction of gravity. In this case, the processor may calculate, based on the output from the acceleration sensor 37, the angle at which the controller 5 tilts, or the direction in which the controller 5 tilts without calculating the angle of tilt. Thus, the acceleration sensor 37 is used in combination with the processor, making it possible to determine the angle of tilt or the attitude of the controller 5.

On the other hand, when it is premised that the controller 5 is in dynamic state (where the controller 5 is being moved), the acceleration sensor 37 detects the acceleration based on the movement of the controller 5, in addition to the gravitational acceleration. Therefore, when the gravitational acceleration component is eliminated from the detected acceleration through a predetermined process, it is possible to determine the direction in which the controller 5 moves. Even when it is premised that the controller 5 is in dynamic state, the acceleration component based on the movement of the acceleration sensor is eliminated from the detected acceleration through a predetermined process, whereby it is possible to determine the tilt of the controller 5 relative to the direction of gravity. In another example embodiment, the acceleration sensor 37 may include an embedded processor or another type of dedicated processor for performing any desired processing on an acceleration signal detected by the acceleration detection means incorporated therein before outputting to the microcomputer 42. For example, when the acceleration sensor 37 is intended to detect static acceleration (for example, gravitational acceleration), the embedded or dedicated processor could convert the acceleration signal to a corresponding angle of tilt (or another preferred parameter).

The gyroscope 48 detects angular rates about three axes (in the present example embodiment, the X-, Y-, and Z-axes). In the present specification, the directions of rotation about the X-axis, the Y-axis, and the Z-axis relative to the imaging direction (the Z-axis positive direction) of the controller 5 are referred to as a pitch direction, a yaw direction, and a roll direction, respectively. So long as the gyroscope 48 can detect the angular rates about the three axes, any number thereof may be used, and also any combination of sensors may be included therein. That is, the two-axis gyroscope 55 detects angular rates in the pitch direction (the direction of rotation about the X-axis) and the roll direction (the direction of rotation about the Z-axis), and the one-axis gyroscope 56 detects an angular rate in the yaw direction (the direction of rotation about the Y-axis). For example, the gyroscope 48 may be a three-axis gyroscope or may include a combination of a two-axis gyroscope and a one-axis gyroscope to detect the angular rates about the three axes. Data representing the angular rates detected by the gyroscope 48 is outputted to the communication unit 36. Alternatively, the gyroscope 48 may simply detect an angular rate about one axis or angular rates about two axes.

Furthermore, the operating unit 82 of the sub-controller 9 includes the analog joy stick 81, the C button, and the Z button. The operating unit 82 outputs stick data and operation button data to the main controller 8 via the connector 84, and the particular stick data and operation button data (referred to as “sub stick data” and “sub operation button data”, respectively) outputted by the operating unit 82 represent the direction and the amount of tilt of the analog stick 81 and the state of input with each button (as to whether the button has been pressed or not).

Furthermore, the acceleration sensor 83 of the sub-controller 9 is of the same type as the acceleration sensor 37 of the main controller 8, and detects accelerations (including a gravitational acceleration) of the sub-controller 9, i.e., force (including gravity) applied to the sub-controller 9. Among all accelerations applied to a detection unit of the acceleration sensor 38, the acceleration sensor 83 detects values for accelerations (linear accelerations) linearly applied along three predetermined axial directions. Data representing the detected accelerations (referred to as “sub acceleration data”) is outputted to the main controller 8 via the connector 84.

In this manner, the sub-controller 9 outputs sub-controller data, including the sub stick data, the sub operation button data, and the sub acceleration data, to the main controller 8.

The communication unit 36 of the main controller 8 includes the microcomputer 42, memory 43, the wireless module 44 and the antenna 45. The microcomputer 42 controls the wireless module 44 for wirelessly transmitting, to the game device 3, data obtained by the microcomputer 42 while using the memory 43 as a storage area in the process.

The sub-controller data from the sub-controller 9 is inputted to the microcomputer 42 and temporarily stored to the memory 43. In addition, data outputted by the operating unit 32, the image-capturing/processing unit 35, the acceleration sensor 37, and the gyroscope 48 to the microcomputer 42 (referred to as “main controller data”) is temporarily stored to the memory 43. Both the main controller and the sub-controller data are transmitted to the game device 3 as operation data (controller operation data). Specifically, at the time of the transmission to the controller communication module 19 of the game device 3, the microcomputer 42 outputs the operation data stored in the memory 43 to the wireless module 44. The wireless module 44 uses, for example, the Bluetooth (registered trademark) technology to modulate the operation data onto a carrier wave of a predetermined frequency, and radiates the low power radio wave signal from the antenna 45. That is, the operation data is modulated onto the low power radio wave signal by the wireless module 44 and transmitted from the controller 5. The controller communication module 19 of the game device 3 receives the low power radio wave signal. The game device 3 demodulates or decodes the received low power radio wave signal to obtain the operation data. The CPU 10 of the game device 3 performs the game process using the operation data obtained from the controller 5. The wireless transmission from the communication unit 36 to the controller communication module 19 is sequentially performed at a predetermined time interval. Since the game process is generally performed at a cycle of 1/60 sec. (corresponding to one frame time), data may be transmitted at a cycle of a shorter time period. The communication unit 36 of the controller 5 outputs, to the controller communication module 19 of the game device 3, the operation data at intervals of 1/200 seconds, for example.

As described above, the main controller 8 can transmit marker coordinate data, acceleration data, angular rate data, and operation button data as operation data representing operations performed thereon. The sub-controller 9 can transmit acceleration data, stick data, and operation button data as operation data representing operations performed thereon. In addition, the game device 3 executes the game process using the operation data as game inputs. Accordingly, by using the controller 5, the user can perform the game operation of moving the controller 5 itself, in addition to conventionally general game operations of pressing operation buttons. For example, it is possible to perform the operations of tilting the main controller 8 and/or the sub-controller 9 to arbitrary attitudes, pointing the main controller 8 to arbitrary positions on the screen, and moving the main controller 8 and/or the sub-controller 9.

Also, in the present example embodiment, the controller 5 is not provided with any display means for displaying game images, but the controller 5 may be provided with a display means for displaying an image or suchlike to indicate, for example, a remaining battery level.

[4. Configuration of the Terminal Device 7]

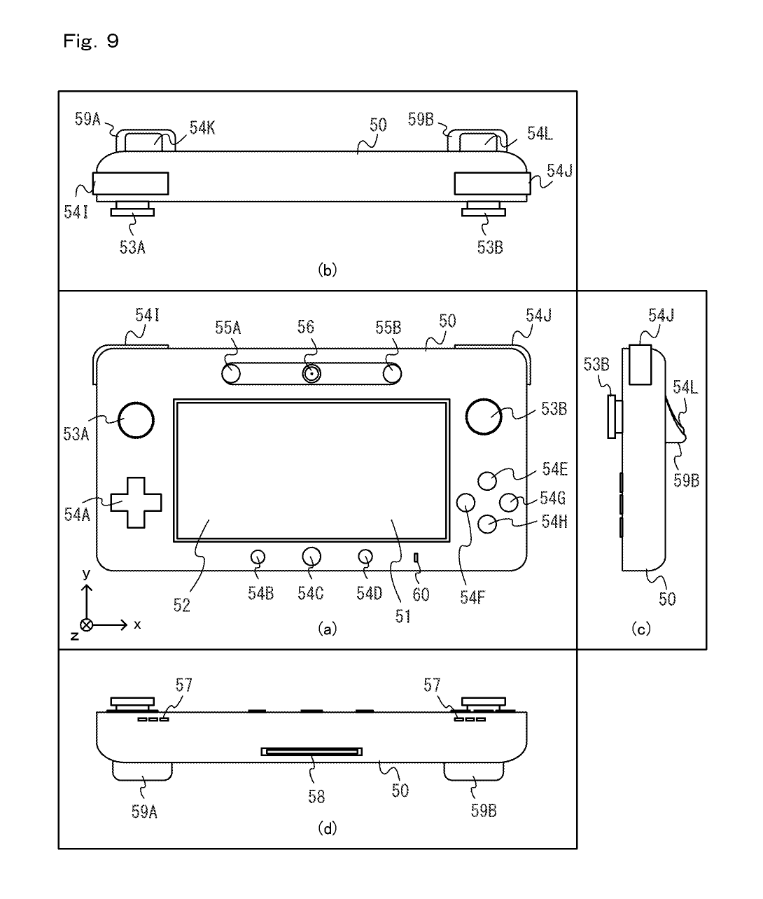

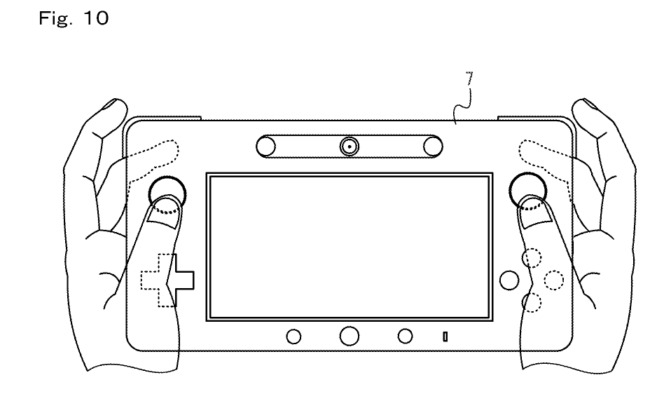

Next, referring to FIGS. 9 to 11, the configuration of the terminal device 7 will be described. FIG. 9 provides views illustrating an external configuration of the terminal device 7. In FIG. 9, parts (a), (b), (c), and (d) are a front view, a top view, a right side view, and a bottom view, respectively, of the terminal device 7. FIG. 10 is a diagram illustrating the terminal device 7 being held by the user.

As shown in FIG. 9, the terminal device 7 has a housing 50 roughly shaped in the form of a horizontally rectangular plate. The housing 50 is sized to be held by the user. Thus, the user can hold and move the terminal device 7, and can change the position of the terminal device 7.

The terminal device 7 includes an LCD 51 on the front surface of the housing 50. The LCD 51 is provided approximately at the center of the surface of the housing 50. Therefore, the user can hold and move the terminal device while viewing the screen of the LCD 51 by holding the housing 50 by edges to the left and right of the LCD 51, as shown in FIG. 10. While FIG. 10 shows an example where the user holds the terminal device 7 horizontal (horizontally long) by holding the housing 50 by edges to the left and right of the LCD 51, the user can hold the terminal device 7 vertical (vertically long).

As shown in FIG. 9(a), the terminal device 7 includes a touch panel 52 on the screen of the LCD 51 as an operating means. In the present example embodiment, a touch panel 52 is a resistive touch panel. However, the touch panel is not limited to the resistive type, and may be of any type such as capacitive. The touch panel 52 may be single-touch or multi-touch. In the present example embodiment, a touch panel having the same resolution (detection precision) as the LCD 51 is used as the touch panel 52. However, the touch panel 52 and the LCD 51 do not have to be equal in resolution. While a stylus is usually used for providing input to the touch panel 52, input to the touch panel 52 can be provided not only by the stylus but also by the user's finger. Note that the housing 50 may be provided with an accommodation hole for accommodating the stylus used for performing operations on the touch panel 52. In this manner, the terminal device 7 includes the touch panel 52, and the user can operate the touch panel 52 while moving the terminal device 7. Specifically, the user can provide input directly to the screen of the LCD 51 (from the touch panel 52) while moving the screen.

As shown in FIG. 9, the terminal device 7 includes two analog sticks 53A and 53B and a plurality of buttons 54A to 54L, as operating means. The analog sticks 53A and 53B are devices capable of directing courses. Each of the analog sticks 53A and 53B is configured such that its stick portion to be operated with the user's finger is slidable (or tiltable) in an arbitrary direction (at an arbitrary angle in any of the up, down, left, right, and oblique directions) with respect to the surface of the housing 50. Moreover, the left analog stick 53A and the right analog stick 53B are provided to the left and the right, respectively, of the screen of the LCD 51. Accordingly, the user can provide an input for course direction using the analog stick with either the left or the right hand. In addition, as shown in FIG. 10, the analog sticks 53A and 53B are positioned so as to allow the user to manipulate them while holding the terminal device 7 at its left and right edges, and therefore the user can readily manipulate the analog sticks 53A and 53B while moving the terminal device 7 by hand.

The buttons 54A to 54L are operating means for providing predetermined input. As will be discussed below, the buttons 54A to 54L are positioned so as to allow the user to manipulate them while holding the terminal device 7 at its left and right edges (see FIG. 10). Therefore the user can readily manipulate the operating means while moving the terminal device 7 by hand.

As shown in FIG. 9(a), of all the operation buttons 54A to 54L, the cross button (direction input button) 54A and the buttons 54B to 54H are provided on the front surface of the housing 50. That is, these buttons 54A to 54H are positioned so as to allow the user to manipulate them with his/her thumbs (see FIG. 10).

The cross button 54A is provided to the left of the LCD 51 and below the left analog stick 53A. That is, the cross button 54A is positioned so as to allow the user to manipulate it with his/her left hand. The cross button 54A is a cross-shaped button which makes it possible to specify at least up, down, left and right directions. Also, the buttons 54B to 54D are provided below the LCD 51. These three buttons 54B to 54D are positioned so as to allow the user to manipulate them with either hand. Moreover, the four buttons 54E to 54H are provided to the right of the LCD 51 and below the right analog stick 53B. That is, the four buttons 54E to 54H are positioned so as to allow the user to manipulate them with the right hand. In addition, the four buttons 54E to 54H are positioned above, to the left of, to the right of, and below the central position among them. Therefore, the four buttons 54E to 54H of the terminal device 7 can be used to function as buttons for allowing the user to specify the up, down, left and right directions.

Furthermore, as shown in FIGS. 9(a), 9(b) and 9(c), the first L button 54I and the first R button 54J are provided at the upper (left and right) corners of the housing 50. Specifically, the first L button 54I is provided at the left edge of the top surface of the plate-like housing 50 so as to be exposed both from the top surface and the left-side surface. The first R button 54J is provided at the right edge of the top surface of the housing 50 so as to be exposed both from the top surface and the right-side surface. Thus, the first L button 54I is positioned so as to allow the user to manipulate it with the left index finger, and the first R button 54J is positioned so as to allow user to manipulate it with the right index finger (see FIG. 10).

Also, as shown in FIGS. 9(b) and 9(c), the second L button 54K and the second R button 54L are positioned at stands 59A and 59B, respectively, which are provided on the back surface of the plate-like housing 50 (i.e., the plane opposite to the surface where the LCD 51 is provided). The second L button 54K is provided at a comparatively high position on the right side of the back surface of the housing 50 (i.e., the left side as viewed from the front surface side), and the second R button 54L is provided at a comparatively high position on the left side of the back surface of the housing 50 (i.e., the right side as viewed from the front surface side). In other words, the second L button 54K is provided at a position approximately opposite to the left analog stick 53A provided on the front surface, and the second R button 54L is provided at a position approximately opposite to the right analog stick 53B provided on the front surface. Thus, the second L button 54K is positioned so as to allow the user to manipulate it with the left middle finger, and the second R button 54L is positioned so as to allow the user to manipulate it with the right middle finger (see FIG. 10). In addition, the second L button 54K and the second R button 54L are provided on the surfaces of the stands 59A and 59B that are directed obliquely upward, as shown in FIG. 9(c), and therefore, the second L button 54K and the second R button 54L have button faces directed obliquely upward. When the user holds the terminal device 7, the middle fingers will probably be able to move in the up/down direction, and therefore the button faces directed upward will allow the user to readily press the second L button 54K and the second R button 54L. Moreover, providing the stands on the back surface of the housing 50 allows the user to readily hold the housing 50, and furthermore, providing the buttons on the stands allows the user to readily manipulate the buttons while holding the housing 50.

Note that the terminal device 7 shown in FIG. 9 has the second L button 54K and the second R button 54L provided at the back surface, and therefore when the terminal device 7 is placed with the screen of the LCD 51 (the front surface of the housing 50) facing up, the screen might not be completely horizontal. Accordingly, in another example embodiment, three or more stands may be formed on the back surface of the housing 50. As a result, when the terminal device 7 is placed on the floor with the screen of the LCD 51 facing upward, all the stands contact the floor (or other flat surfaces), so that the screen can be horizontal. Alternatively, the terminal device 7 may be placed horizontally by adding a detachable stand.

The buttons 54A to 54L are each appropriately assigned a function in accordance with the game program. For example, the cross button 54A and the buttons 54E to 54H may be used for direction-specifying operations, selection operations, etc., whereas the buttons 54B to 54E may be used for setting operations, cancellation operations, etc.

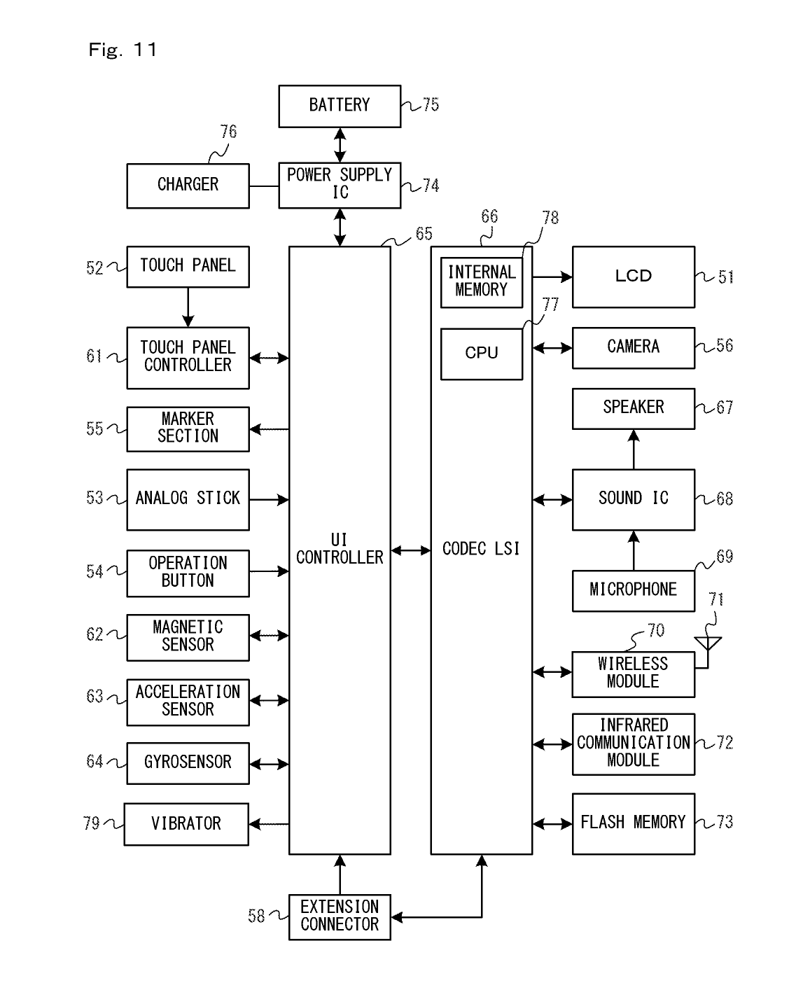

Although not shown in the figures, the terminal device 7 includes a power button for turning ON/OFF the terminal device 7. Moreover, the terminal device 7 may also include buttons for turning ON/OFF the screen of the LCD 51, performing a connection setting (pairing) with the game device 3, and controlling the volume of speakers (speakers 67 shown in FIG. 11).

As shown in FIG. 9(a), the terminal device 7 has a marker unit (a marker unit 55 shown in FIG. 11), including markers 55A and 55B, provided on the front surface of the housing 50. The marker unit 55 may be provided at any position, and is herein provided in the upper portion of the LCD 51. The markers 55A and 55B are each formed by one or more infrared LEDs, as are the markers 6R and 6L of the marker device 6. The marker unit 55 is used for the game device 3 to calculate the movement, etc., of the controller 5 (the main controller 8), as is the marker device 6 described above. In addition, the game device 3 can control the lighting of the infrared LEDs included in the marker unit 55.

The terminal device 7 includes the camera 56 which is an image-capturing means. The camera 56 includes an image-capturing element (e.g., a CCD image sensor, a CMOS image sensor, or the like) having a predetermined resolution, and a lens. As shown in FIG. 8, in the present example embodiment, the camera 56 is provided on the front surface of the housing 50. Therefore, the camera 56 can capture an image of the face of the user holding the terminal device 7, and can capture an image of the user playing a game while viewing the LCD 51, for example. In other embodiments, one or more cameras may be provided in the terminal device 7.

Note that the terminal device 7 includes a microphone (a microphone 69 shown in FIG. 11) which is a sound input means. A microphone hole 60 is provided in the front surface of the housing 50. The microphone 69 is provided inside the housing 50 behind the microphone hole 60. The microphone detects sounds around the terminal device 7 such as the voice of the user. In other embodiments, one or more microphones may be provided in the terminal device 7.

The terminal device 7 includes speakers (speakers 67 shown in FIG. 11) which are sound output means. As shown in FIG. 9(d), speaker holes 57 are provided in the bottom surface of the housing 50. Sound emitted by the speakers 67 is outputted from the speaker holes 57. In the present example embodiment, the terminal device 7 includes two speakers, and the speaker holes 57 are provided at positions corresponding to the left and right speakers. The terminal device 7 may be provided with any number of speakers, and the terminal device 7 may be provided with additional speakers in addition to the two speakers described above.

Also, the terminal device 7 includes an expansion connector 58 for connecting another device to the terminal device 7. In the present example embodiment, the expansion connector 58 is provided at the bottom surface of the housing 50, as shown in FIG. 9(d). Any additional device may be connected to the expansion connector 58, including, for example, a game-specific controller (a gun-shaped controller or suchlike) or an input device such as a keyboard. The expansion connector 58 may be omitted if there is no need to connect any additional devices to terminal device 7.

Note that as for the terminal device 7 shown in FIG. 9, the shapes of the operation buttons and the housing 50, the number and arrangement of components, etc., are merely illustrative, and other shapes, numbers, and arrangements may be employed.

Next, an internal configuration of the terminal device 7 will be described with reference to FIG. 11. FIG. 11 is a block diagram illustrating the internal configuration of the terminal device 7. As shown in FIG. 11, in addition to the components shown in FIG. 9, the terminal device 7 includes a touch panel controller 61, a magnetic sensor 62, the acceleration sensor 63, the gyroscope 64, a user interface controller (UI controller) 65, a codec LSI 66, the speakers 67, a sound IC 68, the microphone 69, a wireless module 70, an antenna 71, an infrared communication module 72, flash memory 73, a power supply IC 74, a battery 75, and a vibrator 79. These electronic components are mounted on an electronic circuit board and accommodated in the housing 50.

The UI controller 65 is a circuit for controlling the input/output of data to/from various input/output units. The UI controller 65 is connected to the touch panel controller 61, an analog stick unit 53 (including the analog sticks 53A and 53B), an operation button group 54 (including the operation buttons 54A to 54L), the marker unit 55, the magnetic sensor 62, the acceleration sensor 63, the gyroscope 64, and the vibrator 79. The UI controller 65 is connected to the codec LSI 66 and the expansion connector 58. The power supply IC 74 is connected to the UI controller 65, and power is supplied to various units via the UI controller 65. The built-in battery 75 is connected to the power supply IC 74 to supply power. A charger 76 or a cable with which power can be obtained from an external power source can be connected to the power supply IC 74 via a charging connector, and the terminal device 7 can be charged with power supplied from an external power source using the charger 76 or the cable. Note that the terminal device 7 can be charged by being placed in an unillustrated cradle having a charging function.

The touch panel controller 61 is a circuit connected to the touch panel 52 for controlling the touch panel 52. The touch panel controller 61 generates touch position data in a predetermined format based on signals from the touch panel 52, and outputs it to the UI controller 65. The touch position data represents, for example, the coordinates of a position (which may be a plurality of positions where the touch panel 52 is of a multi-touch type) on the input surface of the touch panel 52 at which an input has been made. The touch panel controller 61 reads a signal from the touch panel 52 and generates touch position data once per a predetermined period of time. Various control instructions for the touch panel 52 are outputted by the UI controller 65 to the touch panel controller 61.

The analog stick unit 53 outputs, to the UI controller 65, stick data representing the direction and the amount of sliding (or tilting) of the stick portion operated with the user's finger. The operation button group 54 outputs, to the UI controller 65, operation button data representing the input status of each of the operation buttons 54A to 54L (regarding whether it has been pressed).

The magnetic sensor 62 detects an azimuthal direction by sensing the magnitude and the direction of a magnetic field. Azimuthal direction data representing the detected azimuthal direction is outputted to the UI controller 65. Control instructions for a magnetic sensor 62 are outputted by the UI controller 65 to the magnetic sensor 62. While there are sensors using, for example, an MI (magnetic impedance) element, a fluxgate sensor, a Hall element, a GMR (giant magnetoresistance) element, a TMR (tunnel magnetoresistance) element, or an AMR (anisotropic magnetoresistance) element, the magnetic sensor 62 may be of any type so long as it is possible to detect the azimuthal direction. Strictly speaking, in a place where there is a magnetic field in addition to the geomagnetic field, the obtained azimuthal direction data does not represent the azimuthal direction. Nevertheless, if the terminal device 7 moves, the azimuthal direction data changes, and it is therefore possible to calculate the change in the attitude of the terminal device 7.

The acceleration sensor 63 is provided inside the housing 50 for detecting the magnitude of linear acceleration along each direction of three axes (the x-, y- and z-axes shown in FIG. 9(a)). Specifically, the acceleration sensor 63 detects the magnitude of linear acceleration along each axis, where the longitudinal direction of the housing 50 is taken as the x-axis, the width direction of the housing 50 as the y-axis, and a direction perpendicular to the front surface of the housing 50 as the z-axis. Acceleration data representing the detected acceleration is outputted to the UI controller 65. Also, control instructions for the acceleration sensor 63 are outputted by the UI controller 65 to the acceleration sensor 63. In the present example embodiment, the acceleration sensor 63 is assumed to be, for example, a capacitive MEMS acceleration sensor, but in another example embodiment, an acceleration sensor of another type may be employed. The acceleration sensor 63 may be an acceleration sensor for detection in one axial direction or two axial directions.

The gyroscope 64 is provided inside the housing 50 for detecting angular rates about the three axes, i.e., the x-, y-, and z-axes. Angular rate data representing the detected angular rates is outputted to the UI controller 65. Also, control instructions for the gyroscope 64 are outputted by the UI controller 65 to the gyroscope 64. Note that any number and combination of gyroscopes may be used for detecting angular rates about the three axes, and similar to the gyroscope 48, the gyroscope 64 may include a two-axis gyroscope and a one-axis gyroscope. Alternatively, the gyroscope 64 may be a gyroscope for detection in one axial direction or two axial directions.

The vibrator 79 is, for example, a vibration motor or a solenoid, and is connected to the UI controller 65. The terminal device 7 is vibrated by actuation of the vibrator 79 in response to a command from the UI controller 65. Thus, a so-called vibration-feedback game is realized, in which the vibration is conveyed to the user's hand holding the terminal device 7.

The UI controller 65 outputs operation data to the codec LSI 66, including touch position data, stick data, operation button data, azimuthal direction data, acceleration data, and angular rate data received from various components described above. If another device is connected to the terminal device 7 via the expansion connector 58, data representing an operation performed on that device may be further included in the operation data.

The codec LSI 66 is a circuit for performing a compression process on data to be transmitted to the game device 3, and a decompression process on data transmitted from the game device 3. The LCD 51, the camera 56, the sound IC 68, the wireless module 70, the flash memory 73, and the infrared communication module 72 are connected to the codec LSI 66. The codec LSI 66 includes a CPU 77 and internal memory 78. While the terminal device 7 does not perform any game process itself, the terminal device 7 may execute a minimal set of programs for its own management and communication purposes. Upon power-on, the CPU 77 executes a program loaded into the internal memory 78 from the flash memory 73, thereby starting up the terminal device 7. Also, some area of the internal memory 78 is used as VRAM for the LCD 51.

The camera 56 captures an image in response to an instruction from the game device 3, and outputs the captured image data to the codec LSI 66. Also, control instructions for the camera 56, such as an image-capturing instruction, are outputted by the codec LSI 66 to the camera 56. Note that the camera 56 can also record video. Specifically, the camera 56 can repeatedly capture images and repeatedly output image data to the codec LSI 66.

The sound IC 68 is a circuit connected to the speakers 67 and the microphone 69 for controlling input/output of sound data to/from the speakers 67 and the microphone 69. Specifically, when sound data is received from the codec LSI 66, the sound IC 68 outputs to the speakers 67 a sound signal obtained by performing D/A conversion on the sound data so that sound is outputted by the speakers 67. The microphone 69 senses sound propagated to the terminal device 7 (e.g., the user's voice), and outputs a sound signal representing the sound to the sound IC 68. The sound IC 68 performs A/D conversion on the sound signal from the microphone 69 to output sound data in a predetermined format to the codec LSI 66.

The codec LSI 66 transmits, as terminal operation data, image data from the camera 56, sound data from the microphone 69 and operation data from the UI controller 65 to the game device 3 via the wireless module 70. In the present example embodiment, the codec LSI 66 subjects the image data and the sound data to a compression process as the codec LSI 27 does. The terminal operation data, along with the compressed image data and sound data, is outputted to the wireless module 70 as transmission data. The antenna 71 is connected to the wireless module 70, and the wireless module 70 transmits the transmission data to the game device 3 via the antenna 71. The wireless module 70 has a similar function to that of the terminal communication module 28 of the game device 3. Specifically, the wireless module 70 has a function of connecting to a wireless LAN by a scheme in conformity with the IEEE 802.11n standard, for example. Data to be transmitted may or may not be encrypted depending on the situation.

As described above, the transmission data to be transmitted from the terminal device 7 to the game device 3 includes operation data (terminal operation data), image data, and sound data. In the case where another device is connected to the terminal device 7 via the expansion connector 58, data received from that device may be further included in the transmission data. In addition, the infrared communication module 72 performs infrared communication with another device in accordance with, for example, the IRDA standard. Where appropriate, data received via infrared communication may be included in the transmission data to be transmitted to the game device 3 by the codec LSI 66.

As described above, compressed image data and sound data are transmitted from the game device 3 to the terminal device 7. These data items are received by the codec LSI 66 via the antenna 71 and the wireless module 70. The codec LSI 66 decompresses the received image data and sound data. The decompressed image data is outputted to the LCD 51, and images are displayed on the LCD 51. The decompressed sound data is outputted to the sound IC 68, and the sound IC 68 outputs sound from the speakers 67.

Also, in the case where control data is included in the data received from the game device 3, the codec LSI 66 and the UI controller 65 give control instructions to various units in accordance with the control data. As described above, the control data is data representing control instructions for the components of the terminal device 7 (in the present example embodiment, the camera 56, the touch panel controller 61, the marker unit 55, the sensors 62 to 64, the infrared communication module 72, and the vibrator 79). In the present example embodiment, the control instructions represented by the control data are conceivably instructions to activate or deactivate (suspend) the components. Specifically, any components that are not used in a game may be deactivated in order to reduce power consumption, and in such a case, data from the deactivated components is not included in the transmission data to be transmitted from the terminal device 7 to the game device 3. Note that the marker unit 55 is configured by infrared LEDs, and therefore is simply controlled for power supply to be ON/OFF.

While the terminal device 7 includes operating means such as the touch panel 52, the analog sticks 53 and the operation button group 54, as described above, in another example embodiment, other operating means may be included in place of or in addition to these operating means.

Also, while the terminal device 7 includes the magnetic sensor 62, the acceleration sensor 63 and the gyroscope 64 as sensors for calculating the movement of the terminal device 7 (including its position and attitude or changes in its position and attitude), in another example embodiment, only one or two of the sensors may be included. Furthermore, in another example embodiment, any other sensor may be included in place of or in addition to these sensors.

Also, while the terminal device 7 includes the camera 56 and the microphone 69, in another example embodiment, the terminal device 7 may or may not include the camera 56 and the microphone 69 or it may include only one of them.

Also, while the terminal device 7 includes the marker unit 55 as a feature for calculating the positional relationship between the terminal device 7 and the main controller 8 (e.g., the position and/or the attitude of the terminal device 7 as seen from the main controller 8), in another example embodiment, it may not include the marker unit 55. Furthermore, in another example embodiment, the terminal device 7 may include another means as the aforementioned feature for calculating the positional relationship. For example, in another example embodiment, the main controller 8 may include a marker unit, and the terminal device 7 may include an image-capturing element. Moreover, in such a case, the marker device 6 may include an image-capturing element in place of an infrared LED.

[5. Outline of Game Processes]

Next, an outline of game processes to be performed in the game system 1 of the present embodiment will be explained. In the present embodiment, the player controls a player character appearing in a virtual game space using the controller 5. Game images representing the game space are displayed on two display devices, i.e., the television 2 and the terminal device 7. While the portable terminal device 7 may be arranged in any place, when it is arranged beside the television 2, for example, the player can play the game without substantially moving the eyes back and forth between the television 2 and the terminal device 7. While the terminal device 7 is used as a display device in the present embodiment, it may be used not only as a display device but also as a controller device in other embodiments.

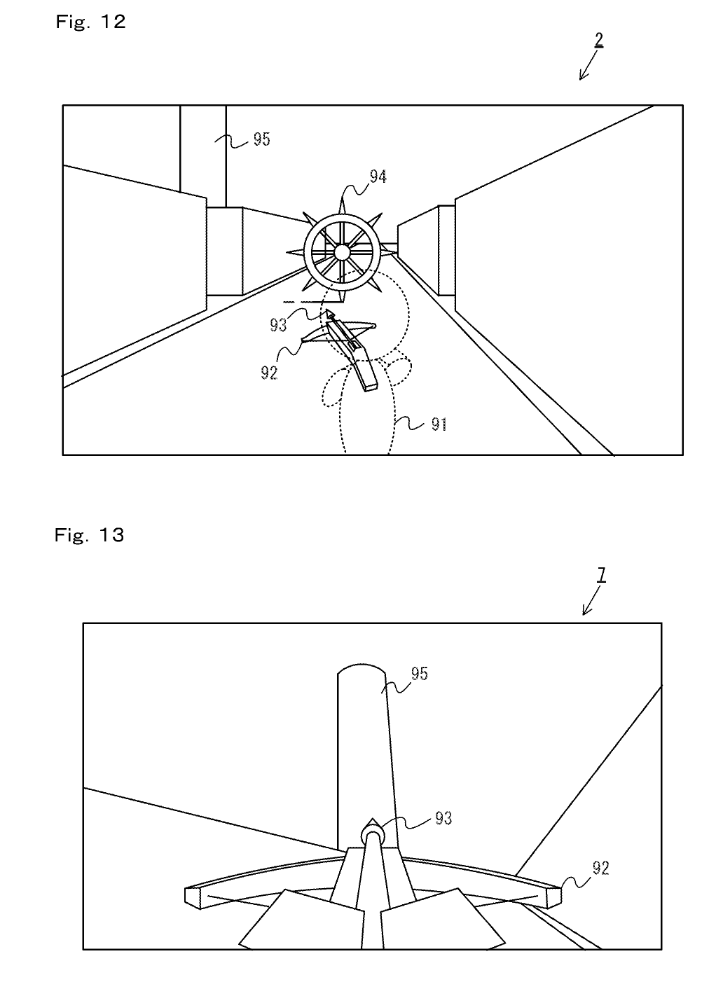

FIG. 12 is a diagram showing an example television game image displayed on the television 2. As can be seen from FIG. 12, a so-called “objective perspective” game image, i.e., a game image representing the game space including a player character 91, is displayed on the television 2. In the present embodiment, the player character 91 is displayed semitransparent (indicated by a dotted line in FIG. 12) on the terminal device 7 so that the player can easily grasp the circumstances of the game space. The television game image is generated using a virtual camera placed in the game space (referred to as the “television camera”). In the present embodiment, the movement (the position and the direction) of the player character 91 are controlled by direction inputs on the analog joy stick 81 of the sub-controller 9. The position and the attitude of the television camera are set in accordance with the movement of the player character 91, the details of which will be described later.

The player character 91 is holding a crossbow 92, and the player character 91 executes an action of launching an arrow 93 from the crossbow 92 in response to an operation by the player. Specifically, the attitude of the crossbow 92 is controlled so that it changes in accordance with the attitude of the controller 5 (the main controller 8). In response to a predetermined launch operation (the operation of pressing the B button 32i of the main controller 8), the arrow 93 is launched in the direction toward the crossbow 92 (the arrow 93) at the point in time when the launch operation is performed.

In the game image shown in FIG. 12, there are intersections surrounded by walls in the game space, and wheels 94 are rolling across the intersections. Each wheel 94 moves across an intersection at regular intervals (or at random intervals). Herein, a goal for the player character 91 is to move across the intersections without touching the wheels 94.

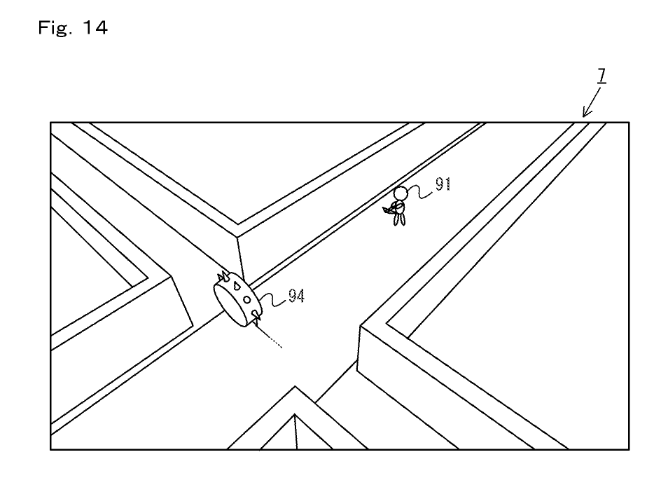

On the other hand, FIG. 13 is a diagram showing an example terminal game image displayed on the terminal device 7. As shown in FIG. 13, the terminal device 7 displays a game image representing the game space as viewed from the position of the arrow 93. Before the arrow 93 is launched, the position of the arrow 93 is near the player character 91 (at the position of the crossbow 92), and the arrow 93 moves together with the player character 91. Therefore, before the arrow 93 is launched, the terminal game image is a so-called “subjective perspective” game image.

The terminal game image is generated using a virtual camera placed in the game space (referred to as the “terminal camera”). That is, the terminal camera is arranged at the position of the arrow 93. In the present embodiment, the direction of the terminal camera changes in accordance with a change in the attitude of the crossbow 92 (the arrow 93). Therefore, in response to a change in the attitude of the controller 5, the attitude of the crossbow 92 changes and also the direction of the terminal camera changes. Since the direction of the terminal camera changes in accordance with the arrow 93, if the terminal camera is facing in the tail-to-tip direction of the arrow 93, the direction of the terminal camera changes in accordance with a change in the attitude of the controller 5 while the terminal camera continues to face in the tail-to-tip direction of the arrow 93.

In the present embodiment, the direction of the terminal camera changes in accordance with a direction input on the controller 5 (e.g., a direction input on the analog joy stick 81 while the C button of the sub-controller 9 is pressed), independent of the attitude of the arrow 93 (the crossbow 92). That is, in the present embodiment, the player cannot only perform an operation of changing the attitude of the controller 5 but also (independent of this operation) change the direction of the terminal camera by the direction input operation described above. Therefore, the player can direct the terminal camera in the tip-to-tail direction of the arrow 93, for example, and can perform a launch operation while the terminal camera is facing in the tip-to-tail direction.

FIG. 14 is a diagram showing an example terminal game image after an arrow is launched. The terminal game image shown in FIG. 14 is a game image displayed on the terminal device 7 when the player character 91 launches the arrow 93 from the state shown in FIG. 13 and the arrow 93 sticks in a pillar 95. The terminal camera is placed at the position of the arrow 93 also after the arrow 93 is launched, as is before the launch. Therefore, if the launched arrow 93 sticks in the pillar 95, a game image representing the game space as viewed from the position where the arrow 93 is stuck is displayed on the terminal device 7 as shown in FIG. 14. Thus, through an operation of launching the arrow 93 with the crossbow 92, the player can specify the position at which the terminal camera is placed. With the game image shown in FIG. 14, the player can view the game space from a position different from the position of the player character 91. With the game image shown in FIG. 14, the player can check the wheel 94 before it enters the intersection, which cannot be seen with the game image shown in FIG. 12. That is, with the game image shown in FIG. 14, the player can play the game with an advantage by appropriately timing the passage of the player character 91 across the intersection. In addition, with the present embodiment, it is possible to display a game image representing the game space as viewed from a position where the player character 91 cannot enter by hitting that position with the arrow 93, and to display a game image representing the game space as viewed from an object that is moving around in the game space by hitting that object with the arrow 93. Thus, the player can see places where the player character 91 cannot enter, and can see various places of the game space without moving around the player character 91 itself.

The direction of the terminal camera is changed in accordance with a direction input on the controller 5 also after the arrow 93 is launched, as is before the launch. The state of FIG. 14 is an example state where the direction of the terminal camera is changed to the rearward direction after the arrow 93 is launched from the state of FIG. 13. The player can change the viewing direction of the terminal game image by performing the direction input operation described above.

As described above, in the present embodiment, the television 2 displays a game image (FIG. 12) showing the game space as viewed from the viewpoint and in the viewing direction in accordance with the movement of the player character 91, and the terminal device 7 displays a game image (FIG. 14) showing the game space as viewed from the position specified by the player. Thus, it is possible to display two game images showing the game space as viewed from two different viewpoints on two display devices. Since the position of the viewpoint in the terminal game image can be set by the player, a place that is a blind spot from the position of the player character 91 can be made visible on the terminal game image, for example. Therefore, with the present embodiment, it is possible to provide, to the player, game images that are easier to view. With the present embodiment, since two game images can be displayed simultaneously by two display devices, the player can play the game smoothly without having to switch between game images.

With the present embodiment, since two game images are displayed on two display devices, it is possible to provide game images that are easier to view as compared with a case where two game images are displayed by splitting the screen of a single display device in two. For example, where the television game image and the terminal game image are displayed on the screen of a single display device (the television 2) while the screen of the television 2 is split in two, if whether the terminal game image is displayed or not displayed can be switched, the display area of the television game image changes by the switching, and the television game image becomes uneasy to view. In contrast, with the present embodiment, the display area of the television game image does not change whether the terminal game image is displayed or not displayed, and it is therefore possible to provide game images that are easier to view.

[6. Details of Game Process]

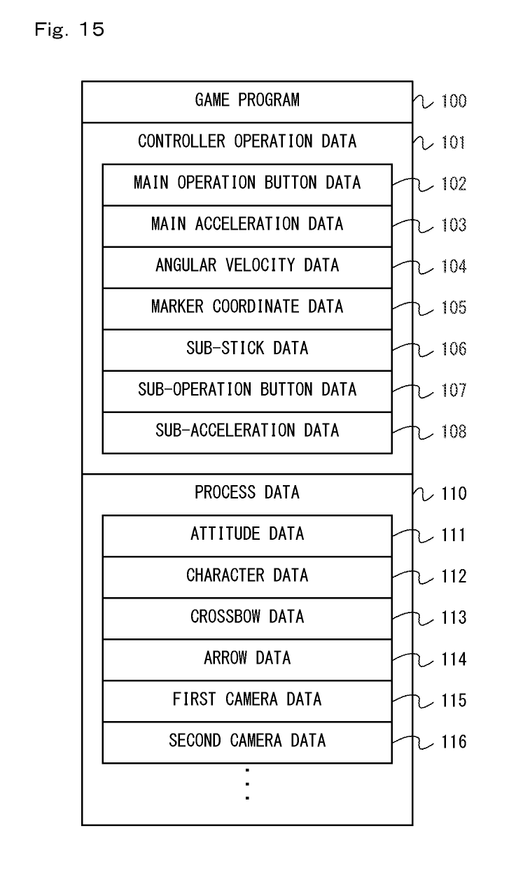

Next, the details of game processes performed by the present game system will be described. First, various data used in the game process will be described. FIG. 15 is a diagram showing various data used in the game processes. FIG. 15 shows primary data to be stored in the main memory (the external main memory 12 or the internal main memory 11e) of the game device 3. As shown in FIG. 15, the main memory of the game device 3 stores a game program 100, controller operation data 101, and process data 110. In addition to those shown in FIG. 15, the main memory also stores other data used in game processes, such as image data of various objects appearing in the game, and sound data used in the game, etc.

At an appropriate point in time after the power of the game device 3 is turned ON, a part or whole of the game program 100 is loaded from the optical disc 4 and stored in the main memory. The game program 100 may be obtained from the flash memory 17 or an external device of the game device 3 (e.g., via the Internet), instead of from the optical disc 4. A part of the game program 100 (e.g., a program for calculating the attitude of the controller 5 and/or the terminal device 7) may be pre-stored in the game device 3.

The controller operation data 101 is data representing an operation performed on the controller 5 by the user (player), and is output (transmitted) from the controller 5 based on an operation performed on the controller 5. The controller operation data 101 is transmitted from the controller 5, and obtained by the game device 3 to be stored in the main memory. The controller operation data 101 includes main operation button data 102, main acceleration data 103, angular velocity data 104, marker coordinate data 105, sub-stick data 106, sub-operation button data 107, and sub-acceleration data 108. Where the game device 3 obtains operation data from a plurality of controllers 5, the controller operation data 101 transmitted from the controllers 5 are separately stored in the main memory. The main memory may store a predetermined number of latest (most recently obtained) sets of the controller operation data 101 for each controller 5.

The main operation button data 102 is data representing the input state of each of the operation buttons 32a to 32i provided on the main controller 8. Specifically, the main operation button data 102 represents whether each of the operation buttons 32a to 32i is being pressed.

The main acceleration data 103 is data representing the acceleration (acceleration vector) detected by the acceleration sensor 37 of the main controller 8. While the main acceleration data 103 herein represents three-dimensional acceleration of which each component is the acceleration for one of the three axes of x, y and z shown in FIG. 3, it may represent acceleration for any one or more directions in other embodiments.

The angular velocity data 103 is data representing the angular velocity detected by the gyrosensor 48 of the main controller 8. While the angular velocity data 104 represents angular velocity about each of the three axes of x, y and z shown in FIG. 3, it may represent angular velocity about any one or more axes in other embodiments. Thus, in the present embodiment, the controller 5 includes the gyrosensor 48, and the angular velocity data 104 is included in the controller operation data 101 as a physical quantity used for calculating the attitude of the controller 5. Therefore, the game device 3 can calculate the attitude of the controller 5 accurately based on angular velocity.

The marker coordinate data 105 is data representing coordinates calculated by the image processing circuit 41 of the image-capturing/processing unit 35, i.e., the marker coordinates. The marker coordinates are represented in a two-dimensional coordinate system for representing a position on a plane corresponding to the captured image, and the marker coordinate data 105 represents the coordinate values in the two-dimensional coordinate system.

The sub-stick data 106 is data representing an operation performed on the analog joy stick 81 of the sub-controller 9. Specifically, the sub-stick data 106 represents the direction and the amount of tilt of the analog joy stick 81.

The sub-operation button data 107 is data representing the input state of each of the operation buttons provided on the sub-controller 9. Specifically, the sub-operation button data 107 represents whether each of the operation buttons is being pressed.

The sub-acceleration data 108 is data representing the acceleration (acceleration vector) detected by the acceleration sensor 83 of the sub-controller 9. While the sub-acceleration data 108 herein represents three-dimensional acceleration of which each component is the acceleration for one of the three axes of x′, y′ and z′ shown in FIG. 7, it may represent acceleration for any one or more directions in other embodiments.

As long as the controller operation data 101 represents the operation of the player operating the controller 5, it may include only some of the various data 102 to 108. In a case in which the controller 5 includes another input unit (e.g., a touch panel, an analog stick, or the like), the controller operation data 101 may include data representing the operation performed on the other input unit. In a case in which the movement of the controller 5 itself is used as the game operation as in the present embodiment, the controller operation data 101 includes data whose value varies in accordance with the attitude of the controller 5 itself, such as the main acceleration data 103, the angular velocity data 104, the marker coordinate data 105 or the sub-acceleration data 108.

Although it is now shown in the figures because the terminal device 7 is not used as a controller device in the present embodiment, terminal operation data representing operations of the player on the terminal device 7 may be obtained from the terminal device 7 and stored in the main memory.

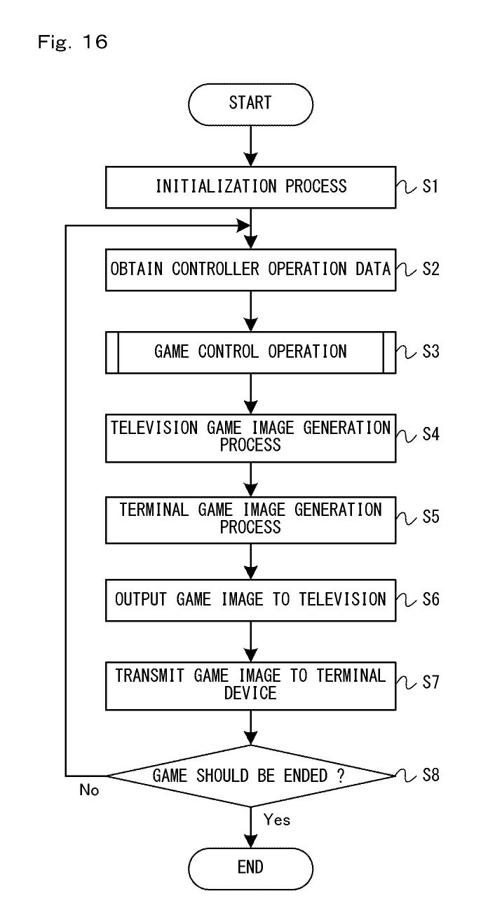

The process data 110 is data used in game processes to be described below (FIG. 16). The process data 110 includes attitude data 111, character data 112, crossbow data 113, arrow data 114, television camera data 115, and terminal camera data 116. In addition to the data shown in FIG. 15, the process data 110 includes various data used in game processes such as data representing various parameters set for various objects appearing in the game.

The attitude data 111 is data representing the attitude of the controller 5 (more specifically, the main controller 8). For example, the attitude of the controller 5 may be expressed by a rotation matrix that represents the rotation from a predetermined reference attitude to the current attitude, or may be expressed by a third-order vector or three angles. While the attitude in the three-dimensional space is used as the attitude of the controller 5 in the present embodiment, the attitude in the two-dimensional plane may be used in other embodiments. The attitude data 111 is calculated based on the main acceleration data 103, the angular velocity data 104 and the marker coordinate data 105 included in the controller operation data 101 from the controller 5. The method for calculating the attitude of the controller 5 will be later described in step S11.

The character data 112 is data representing the position and the direction of the player character 91. It represents various information set in the player character 91 (herein, the position and the direction thereof in the game space). In the present embodiment, the position and the direction of the player character 91 are calculated based on the sub-stick data 106 from the controller 5.

The crossbow data 113 is data representing the position and the attitude (shooting direction) of the crossbow 92 held by the player character 91. In the present embodiment, the position of the crossbow 92 is calculated based on the position of the player character 91, and the attitude of the crossbow 92 is calculated based on the attitude data 111 described above, the details of which will be described later.

The arrow data 114 is data representing the position, the attitude and the movement state of the arrow 93. The arrow 93 moves together with the crossbow 92 before it is launched, and moves in the shooting direction from the position of the crossbow 92 after it is launched. Then, when the arrow 93 contacts another object in the game space, the arrow 93 stops at the position of contact. The movement state indicates whether the arrow 93 has not been launched, the arrow 93 is moving, or the arrow 93 has stopped moving. The arrow data 114 represents one of these states.

The television camera data 115 represents the position and the attitude of the television camera set in the game space. In the present embodiment, the television camera is set based on the position and the direction of the player character 91.

The terminal camera data 116 represents the position and the attitude of the terminal camera set in the game space. In the present embodiment, the terminal camera is set based on the position of the arrow 93.

Next, the details of game processes performed by the game device 3 will be described with reference to FIGS. 16 to 19. FIG. 16 is a main flow chart showing the flow of game processes performed by the game device 3. When the power of the game device 3 is turned ON, the CPU 10 of the game device 3 executes a boot program stored in a boot ROM (not shown), so as to initialize each unit, including the main memory. Then, the game program stored in the optical disc 4 is loaded to the main memory, and the CPU 10 starts executing the game program. The flow chart shown in FIG. 16 is a flow chart showing the process to be performed after processes described above are completed. The game device 3 may be configured to execute the game program immediately after power-up, or it may be configured so that a built-in program is executed after power-up for displaying a predetermined menu screen first, and then the game program is executed in response to a user's instruction to start the game.

The processes of the steps of the flow chart shown in FIGS. 16 to 19 are merely illustrative, and the order of steps to be performed may be switched around as long as similar results are obtained. The values of the variables, and the threshold values used in determination steps are also merely illustrative, and other values may be used as necessary. While the present embodiment is described assuming that the processes of the steps of the flow chart are performed by the CPU 10, processes of some of the steps of the flow chart may be performed by a processor or a dedicated circuit other than the CPU 10.

First, in step S1, the CPU 10 performs an initialization process. The initialization process is a process of constructing a virtual game space, placing objects appearing in the game space at their initial positions, and setting initial values of various parameters used in the game processes. In the present embodiment, the player character 91 is arranged at a predetermined position and in a predetermined direction. That is, data representing the predetermined position and direction is stored in the main memory as the character data 112. The television camera is set in an initial position and in an initial attitude in accordance with the position and the direction of the player character 91. Moreover, the position and the attitude of the crossbow 92 (the arrow 93) are determined in accordance with the position and the direction of the player character 91, and the terminal camera is set in accordance with the position and the attitude of the arrow 93. Data representing the initial position and the initial attitude of the television camera is stored in the main memory as the television camera data 115, and data representing the initial position and the initial attitude of the terminal camera is stored in the main memory as the terminal camera data 116. Data representing the direction of the crossbow 92 is stored as the crossbow data 113 in the main memory. The process of step S2 is performed, following step S1. Thereafter, the process loop including a series of processes of steps S2 to S8 is repeatedly performed at a rate of once per a predetermined amount of time (a one frame period, e.g., 1/60 sec).

In step S2, the CPU 10 separately obtains controller operation data transmitted from two controllers 5. Since each controller 5 repeatedly transmits the controller operation data to the game device 3, the controller communication module 19 in the game device 3 successively receives the controller operation data, and the received controller operation data are successively stored in the main memory by the input/output processor 11a. The transmission/reception interval between the controller 5 and the game device 3 may be shorter than the game process time, and is 1/200 sec, for example. In step S2, the CPU 10 reads out the latest controller operation data 101 from the main memory. The process of step S3 is performed, following step S2.

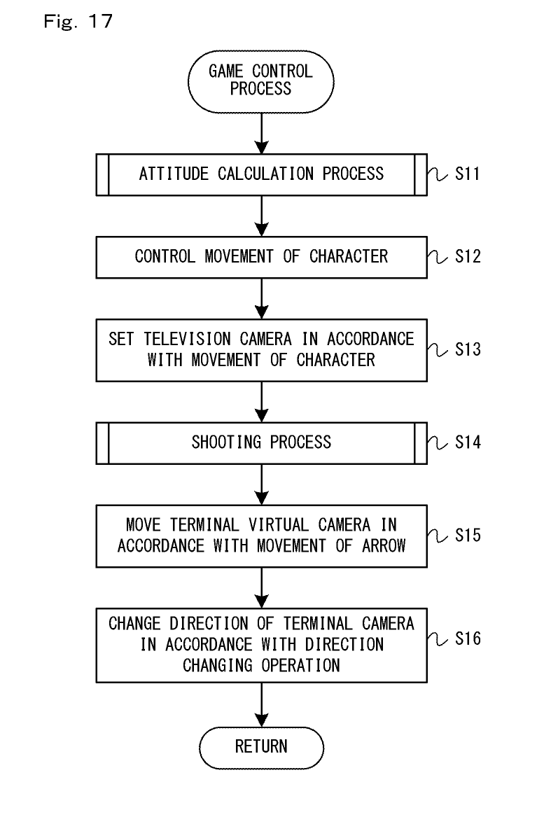

In step S3, the CPU 10 performs the game control process. The game control process allows the game to progress by performing, for example, a process of making different objects (including the player character 91) in the game space execute actions in accordance with game operations by the player. Specifically, in the game control process of the present embodiment, a process of controlling the action of the player character 91, a process of controlling each virtual camera, etc., are performed. The details of the game control process will now be described with reference to FIG. 17.

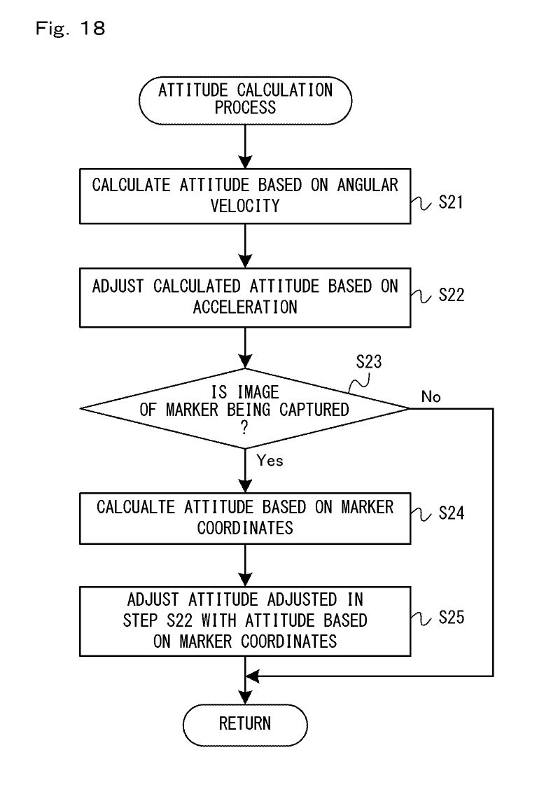

FIG. 17 is a flow chart showing a detailed flow of the game control process (step S3) shown in FIG. 16. In the game control process, first, in step S11, the CPU 10 performs the attitude calculation process. The attitude calculation process in step S11 is a process of calculating the attitude of the controller 5 (the main controller 8) based on the physical quantity for calculating the attitude which is included in the operation data of the controller 5. In the present embodiment, the angular velocity detected by the gyrosensor 48, the acceleration detected by the acceleration sensor 37, and the marker coordinates calculated by the image-capturing/processing unit 35 are used as physical quantities for calculating the attitude. The details of the attitude calculation process will now be described with reference to FIG. 18.

FIG. 18 is a flow chart showing a detailed flow of the attitude calculation process (step S11) shown in FIG. 17. In the attitude calculation process, first, in step S21, the CPU 10 calculates the attitude of the controller 5 based on the angular velocity data 104. While the method for calculating the attitude based on the angular velocity may be any method, the attitude is calculated using the previous attitude (the attitude calculated in step S11 in a previous iteration of the process loop) and the current angular velocity (the angular velocity obtained in step S2 in a current iteration of the process loop). Specifically, the CPU 10 calculates the attitude by rotating the previous attitude by a unit time's worth of the current angular velocity. The previous attitude is represented by the attitude data 111 stored in the main memory, and the current angular velocity is represented by the angular velocity data 104 stored in the main memory. Therefore, the CPU 10 reads out the attitude data 111 and the angular velocity data 104 from the main memory to calculate the attitude of the controller 5. The data representing the attitude calculated as described above is stored in main memory. The process of step S22 is performed, following step S21.

Where the attitude is calculated from the angular velocity in step S21, an initial attitude may be set. That is, where the attitude of the controller 5 is calculated from the angular velocity, the CPU 10 initially sets the initial attitude of the controller 5. The initial attitude of the controller 5 may be calculated based on the main acceleration data 103, or the player may be prompted to perform a predetermined operation with the controller 5 in a particular attitude so that the particular attitude at the point in time when the predetermined operation is performed is set as the initial attitude. While the initial attitude may be calculated in a case in which the attitude of the controller 5 is calculated as an absolute attitude with respect to a predetermined direction in the space, the initial attitude may not be calculated in a case in which the attitude of the controller 5 is calculated as a relative attitude with respect to the attitude of the controller 5 at the start of the game, for example.

In step S22, the CPU 10 adjusts the attitude calculated in step S21 based on the acceleration of the controller 5. In a state in which the controller 5 is substantially stationary, the acceleration acting upon the controller 5 means the gravitational acceleration. That is, in this state, the acceleration vector represented by the main acceleration data 103 for the controller 5 represents the direction of gravity in the controller 5. Therefore, the CPU 10 makes an adjustment such that the downward direction (the direction of gravity) of the attitude calculated in step S21 is brought closer to the direction of gravity represented by the acceleration vector. That is, the attitude is rotated so that the downward direction is brought closer to the direction of gravity represented by the acceleration vector at a predetermined rate. Thus, the attitude based on the angular velocity can be adjusted to an attitude based on the acceleration with the direction of gravity taken into consideration. The predetermined rate may be a predetermined fixed value or may be set in accordance with the detected acceleration, etc. For example, the CPU 10 may increase the rate at which the downward direction of the attitude is brought closer to the direction of gravity represented by the acceleration vector when the magnitude of the detected acceleration is close to the magnitude of the gravitational acceleration, and decrease the rate when the magnitude of the detected acceleration is remote from the magnitude of the gravitational acceleration.

As a specific process of step S22, the CPU 10 reads out data representing the attitude calculated in step S21 and the main acceleration data 103 from the main memory, and makes the adjustment described above. Then, data representing the attitude after the adjustment is made is stored in the main memory. The process of step S23 is performed, following step S22.

In step S23, the CPU 10 determines whether the image of the markers (the markers 55a and 55b of the marker unit 55 of the terminal device 7 or the markers 6R and 6L of the marker device 6) is captured by the image-capturing unit (the image-capturing element 40) of the controller 5. The determination of step S23 can be made by referencing the marker coordinate data 105 for the controller 5 stored in the main memory. Herein, it is determined that the image of the markers is captured when the marker coordinate data 105 represents two sets of marker coordinates, and it is determined that the image of the markers is not captured when the marker coordinate data 105 represents only one set of marker coordinates or when it indicates that there is no marker coordinate. In a case in which the determination result of step S23 is affirmative, subsequent processes of steps S24 and S25 are performed. On the other hand, in a case in which the determination result of step S23 is negative, the CPU 10 ends the attitude calculation process, skipping the process of steps S24 and S25. Thus, in a case in which the image of the markers is not captured by the image-capturing element 40, the attitude of the controller 5 (the attitude based on the marker coordinates) using data obtained from the image-capturing element 40, in which case the adjustment using this attitude is not performed.

In the present embodiment, the marker device 6 is used as the object whose image is captured by the controller 5. That is, the game device 3 performs a control so that the marker device 6 is lit and the marker unit 55 is not lit. In other embodiments, only the marker unit 55 may be lit and used as the object whose image is captured by the controller 5, or the marker device 6 and the marker unit 55 are lit in a time-division manner and the both markers may be used as the object whose image is captured by the controller 5 depending on the circumstances.

In step S24, the CPU 10 calculates the attitude of the controller 5 based on the marker coordinates. Since the marker coordinates represent the positions of two markers (the markers 6L and 6R or the markers 55A and 55B) in the captured image, it is possible to calculate the attitude of the controller 5 from these positions. The method for calculating the attitude of the controller 5 based on the marker coordinates will now be described. The roll direction, the yaw direction and the pitch direction as used hereinbelow refer to the rotation direction about the Z axis, the rotation direction about the Y axis and the rotation direction about the X axis, respectively, of the controller 5 in a state (reference state) in which the image-capturing direction (the Z-axis direction) of the controller 5 points at the marker.

First, the attitude for the roll direction (the rotation direction about the Z axis) can be calculated from the gradient of the straight line extending between the two sets of marker coordinates in the captured image. That is, when calculating the attitude for the roll direction, the CPU 10 first calculates the vector extending between two sets of marker coordinates. Since the direction of this vector varies in accordance with the rotation of the controller 5 in the roll direction, the CPU 10 can calculate the attitude for the roll direction based on the vector. For example, the attitude for the roll direction may be calculated as a rotation matrix for rotating the vector in a predetermined attitude to the current vector, or may be calculated as an angle between the vector in a predetermined attitude and the current vector.

Where the position of the controller 5 can be assumed to be generally fixed, the attitude of the controller 5 for the pitch direction (the rotation direction about the X axis) and the attitude for the yaw direction (the rotation direction about the Y axis) can be calculated from the positions of the marker coordinates in the captured image. Specifically, the CPU 10 first calculates the position of the middle point between the two sets of marker coordinates. That is, in the present embodiment, the position of the middle point is used as the position of the marker in the captured image. Next, the CPU 10 makes an adjustment of rotating the middle point, about the central position of the captured image as the center, by the angle of rotation for the roll direction of the controller 5 (in the direction opposite to the rotation direction of the controller 5). In other words, the middle point is rotated, about the central position of the captured image as the center, so that the vector described above faces in the horizontal direction.

The attitude of the controller 5 for the yaw direction and that for the pitch direction can be calculated from the adjusted middle point position obtained as described above. That is, in the reference state, the adjusted middle point position is the central position of the captured image. The adjusted middle point position moves from the central position of the captured image by an amount that is determined in accordance with the amount by which the attitude of the controller 5 has changed from the reference state and in a direction that is opposite to the direction in which the attitude of the controller 5 has changed. Thus, the direction and the amount (angle) by which the attitude of the controller 5 has changed from the reference state are calculated based on the direction and the amount of change in the adjusted middle point position with respect to the central position of the captured image. Since the yaw direction of the controller 5 corresponds to the horizontal direction of the captured image and the pitch direction of the controller 5 corresponds to the vertical direction of the captured image, it is possible to individually calculate the attitude for the yaw direction and that for the pitch direction.

In the game system 1, since the posture in which the player plays the game (whether the player is standing up or sitting down, etc.) and the position of the marker (whether the marker device 6 is arranged on top of or under the television 2) vary, the assumption that the position of the controller 5 is generally fixed may not hold true for the vertical direction. That is, in the present embodiment, since it may not be possible to accurately calculate the attitude for the pitch direction, the CPU 10 uses the attitude adjusted in step S22 for the pitch direction, instead of calculating the attitude based on the marker coordinates for the pitch direction.

As described above, in step S24, the CPU 10 reads out the marker coordinate data 105 from the main memory, and calculates the attitude for the roll direction and the attitude for the yaw direction based on two sets of marker coordinates. The CPU 10 also reads out data representing the attitude adjusted in step S22, and extracts the attitude for the pitch direction. Where the attitude for each direction is calculated as a rotation matrix, for example, the attitude of the controller 5 can be obtained by adding together the rotation matrices for different directions. Data representing the calculated attitude is stored in the main memory. The process of step S25 is performed, following step S24.

In step S25, the CPU 10 adjusts the attitude based on the angular velocity using the attitude based on the marker coordinates. Specifically, the CPU 10 reads out data representing the attitude adjusted in step S22 (the attitude based on the angular velocity) and data representing the attitude calculated in step S24 (the attitude based on the marker coordinates) from the main memory, and makes an adjustment such that the attitude based on the angular velocity is brought closer to the attitude based on the marker coordinates at a predetermined rate. The predetermined rate may be a predetermined fixed value, for example. Data representing the adjusted attitude obtained as described above is stored in the main memory as new attitude data 111. That is, the attitude data 111 after the adjustment process in step S25 is used in subsequent processes as the final attitude of the controller 5. After step S25, the CPU 10 ends the attitude calculation process.

In the present embodiment, the CPU 10 calculates the attitude for the roll direction and the attitude for the yaw direction based on the marker coordinates, and the attitude adjustment process using the marker coordinates is not performed for the pitch direction. Note however that in other embodiments, the CPU 10 may calculate the attitude (for the pitch direction) based on the marker coordinates in a manner similar to that for the yaw direction also for the pitch direction, and may perform the attitude adjustment process using the marker coordinates also for the pitch direction.

With attitude calculation process described above, the CPU 10 adjusts the attitude of the controller 5 calculated based on the angular velocity data 104, using the main acceleration data 103 and the marker coordinate data 105. With the method using the angular velocity, among other methods for calculating the attitude of the controller 5, it is possible to calculate the attitude no matter how the controller 5 is moving. On the other hand, with the method using the angular velocity, since the attitude is calculated by cumulatively adding successively-detected angular velocities, the precision may deteriorate due to error accumulation, etc., or the precision of the gyrosensor 48 may deteriorate due to the so-called “temperature drift” problem. With the method using the acceleration, errors do not accumulate, but it is not possible to precisely calculate the attitude in a state where the controller 5 is being moved violently (because the direction of gravity cannot be detected accurately). With the method using the marker coordinates, it is possible to precisely calculate the attitude (particularly for the roll direction), but it is not possible to calculate the attitude in a state where it is not possible to capture an image of the markers. With the present embodiment, it is possible to more accurately calculate the attitude of the controller 5 because three different methods having different characteristics as described above are used. In other embodiments, the attitude may be calculated using one or two of the three methods described above.

In the present embodiment, the attitude of the controller 5 is calculated using the detection results of the inertia sensors of the controller 5 (the acceleration sensor 37 and the gyrosensor 48). In other embodiments, the method for calculating the attitude of the controller 5 may be any method. For example, in other embodiments, where the controller 5 includes other sensor units (e.g., the magnetic sensor 62 and the camera 56), the attitude of the controller 5 may be calculated using the detection results of the other sensor units. For example, where the game system 1 includes a camera for capturing an image of the controller 5, the game device 3 may obtain the image-capturing results of capturing the image of the controller 5 with the camera to calculate the attitude of the controller 5 using the image-capturing results.

Referring back to FIG. 17, in step S12 following step S11, the CPU 10 controls the action of the player character 91 based on the controller operation data 101. In the present embodiment, the player character 91 is moved by changing the position and the direction in accordance with the direction input on the analog joy stick 81. Specifically, the player character 91 faces in a direction based on the viewing direction of the television camera and the direction input on the analog joystick 81 and moves in that direction. For example, the player character 91 faces and moves in the viewing direction of the television camera (i.e., the front direction of the game space displayed in the television game image in response to an input on the analog joy stick 81 in the straight up direction, and the player character 91 faces and moves in the rightward direction with respect to the viewing direction of the television camera in response to an input on the analog joy stick 81 in the rightward direction. The specific movement method of the player character 91 may be any method, and the movement of the player character 91 may be controlled so that it translates (i.e., moves without changing the direction) in a direction determined in accordance with the direction input on the analog joy stick 81 in other embodiments.

As a specific process of step S12, the CPU 10 reads out the character data 112 from the main memory, and calculates the position and the direction of the player character 91 after the movement based on the controller operation data 101 obtained in step S2 and the character data 112. Then, data representing the calculated position and direction after the movement is stored in the main memory as new character data 112. The process of step S13 is performed, following step S12.

In step S13, the CPU 10 controls the television camera in the game space in accordance with the movement of the player character 91. In the present embodiment, the television camera is set so that the player character 91 is included in the viewing field range. Specifically, the television camera is set at a position that is behind the player character 91 by a predetermined distance so as to be facing the player character 91. In other embodiments, the television camera may be controlled so as to follow the movement of the player character 91 as if it were dragged around by the player character 91, so as to prevent the viewing direction of the television camera from changing abruptly. That is, the television camera may be set at a position that is at a predetermined distance from the player character 91 and in a direction such that the television camera follows the direction of the player character 91 with a delay. As a specific process of step S13, the CPU 10 reads out the character data 112 from the main memory and calculates the position and the direction of the television camera. Then, data representing the calculated position and direction is stored in the main memory as the television camera data 115. The process of step S14 is performed, following step S13.

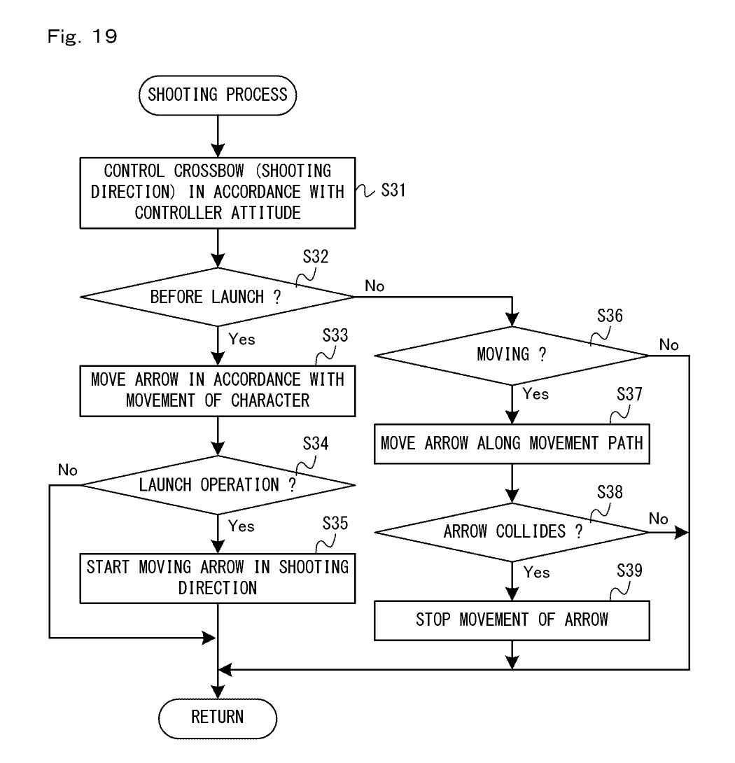

In step S14, the CPU 10 performs a shooting process. A shooting process is a process of controlling the shooting direction of the crossbow 92 held by the player character 91, and launching the arrow 93 in the shooting direction. The details of the shooting process will now be described with reference to FIG. 19.

FIG. 19 is a flow chart showing the detailed flow of the shooting process (step S14) shown in FIG. 17. In the shooting process, first, in step S31, the CPU 10 controls the shooting direction of the crossbow 92 (i.e., the attitude of the crossbow 92) based on the attitude of the controller 5. Specifically, the CPU 10 calculates the position and the attitude of the crossbow 92. The position of the crossbow 92 is set at a predetermined position determined from the position of the player character 91 calculated in step S12. The attitude of the crossbow 92 is calculated so as to correspond to the attitude of the controller 5 in the real space. Specifically, the attitude of the controller 5 when the Z-axis positive direction thereof is extending horizontal and toward the marker device 6 is defined as the reference attitude, and the crossbow 92 faces in the front direction of the player character 91 when the controller 5 is in the reference attitude. When the controller 5 rotates from the reference attitude, the crossbow 92 is rotated from the attitude of the crossbow 92 in the reference attitude by an amount that is determined in accordance with the amount by which the attitude of the controller 5 has changed and in the direction in which the attitude of the controller 5 has changed. The attitude of the crossbow 92 may be controlled in any manner as long as it changes in accordance with the change in the attitude of the controller 5. As a specific process of step S31, the CPU 10 reads out the attitude data 111 and the character data 112 from the main memory, and calculates the position of the crossbow 92 based on the position of the player character 91. The CPU 10 also calculates the attitude of the crossbow 92 based on the attitude of the controller 5 and the direction of the player character 91. Data representing the calculated position and attitude of the crossbow 92 is stored in the main memory as the crossbow data 113. The process of step S32 is performed, following step S31.

In step S32, the CPU 10 determines whether it is before the launch of the arrow 93 from the crossbow 92. The CPU 10 reads out the arrow data 114 from the main memory, and determines whether the arrow data 114 indicates that it is before the launch of the arrow 93. If the determination result of step S32 is affirmative, the process of step S33 is performed. If the determination result of step S32 is negative, the process of step S36 to be described later is performed.

In step S33, the CPU 10 moves the arrow 93 in accordance with the movement of the player character 91 and the crossbow 92. That is, the arrow 93 is set at a position of the crossbow 92 and in an attitude facing in the shooting direction. Therefore, data which represents the set position and attitude of the arrow 93 and which indicates that it is before the launch is stored in the main memory as the arrow data 114. The process of step S34 is performed, following step S33.

In step S34, the CPU 10 determines whether the launch operation has been performed. The launch operation is an operation for making the player character 91 execute a shooting action, and is an operation of pressing a predetermined button (herein, the B button 32i of the main controller 8), for example. Specifically, the CPU 10 determines whether the predetermined button has been pressed by referencing the main operation button data 102 obtained in step S2. If the determination result of step S34 is affirmative, the process of step S35 is performed. On the other hand, if the determination result of step S34 is negative, the CPU 10 ends the shooting process, skipping the process of step S35.

In step S35, the CPU 10 starts the movement of the arrow 93 in the shooting direction. First, the CPU 10 reads out the crossbow data 113 from the main memory, and calculates the movement path of the arrow 93 to be moved from the position of the crossbow 92 in the shooting direction determined in step S31 in accordance with a predetermined movement rule. Data representing the calculated movement path is stored in the main memory. The predetermined movement rule is pre-set in the game program 100, and the specific movement method may be any method. For example, the arrow 93 may be controlled to move in a straight line in the shooting direction, or may be controlled to move in a parabolic line taking into consideration the influence of the gravity defined in the game space. In other embodiments, the movement of the object which moves together with the terminal camera (the arrow 93 in the present embodiment) may be controlled in accordance with operations by the player. The movement direction of the arrow 93 at the start of movement may be a direction that is determined by the shooting direction, and does not need to be equal to the shooting direction. For example, where the arrow 93 moves in a parabolic line, if the movement direction of the arrow 93 at the start of movement is set to be equal to the shooting direction, the player may feel as if the arrow 93 were launched in a lower trajectory than the shooting direction. In such a case, the CPU 10 may launch (move) the arrow 93 in a trajectory slightly upward from the shooting direction.

Following the calculation of the movement path, the CPU 10 moves the arrow 93 along the movement path by a predetermined distance. The predetermined distance is a distance of movement of the arrow 93 per one frame period. Data which represents the position and the attitude of the arrow 93 after the movement and which indicates that the arrow 93 is moving is stored in the main memory as the arrow data 114. The CPU 10 ends the shooting process after step S35.

As described above, in the present embodiment, the shooting direction is determined by the operation of changing the attitude of the controller 5 (step S31), and the destination position of the arrow 93 in the game space is specified in response to the launch operation (step S35). In the present embodiment, the terminal camera is placed at this destination position, the details of which will be described later in step S15. That is, in the present embodiment, a position in the game space is specified by an operation of the player (operation data), and the terminal camera is set at the specified position.

The CPU 10 specifies a direction in the game space (shooting direction) based on an operation by the player (operation data) (step S31), and specifies a position determined by the specified direction (the destination position of the arrow 93) (step S35). Thus, with the present embodiment, the player can specify the position of the virtual camera by specifying the direction in the game space. Then, it is possible to increase the level of difficulty in the operation of specifying the camera setting position, thereby improving the playability of the game. That is, the game of the present embodiment presents the fun of deciding the position to set the virtual camera in the game space so as to gain an advantage in the game, and also the fun of being required of the control skills for setting the virtual camera at an intended position, thereby further improving the playability of the game. The operation of setting the virtual camera can be applied to various games, including the application to a shooting operation as in the present embodiment.

The CPU 10 calculates the specified position (the destination position of the arrow 93) so that the position changes in accordance with a change in the attitude of the controller 5 (steps S31 and S35). Therefore, the player can specify the virtual camera setting position by an intuitive and easy operation using the controller 5.

On the other hand, in step S36, the CPU 10 determines whether the arrow 93 is moving. That is, the CPU 10 reads out the arrow data 114 from the main memory, and determines whether the arrow data 114 indicates that the arrow 93 is moving. If the determination result of step S36 is affirmative, the process of step S37 is performed. If the determination result of step S36 is negative, the CPU 10 ends the shooting process.

In step S37, the CPU 10 moves the arrow 93 along the movement path calculated in step S35. The CPU 10 reads out data representing the movement path and the arrow data 114 from the main memory, and calculates the position and the attitude of the arrow 93 after the arrow 93 is moved along the movement path from the current position of the arrow 93. The arrow 93 is moved by an amount for one frame time in one iteration of step S37. The CPU 10 stores data which represents the position and the attitude after the movement and which indicates that the arrow is moving in the main memory as new arrow data 114. Thus, in the present embodiment, the CPU 10 performs the process of moving an object (the arrow 93) in the game space to the specified position in response to a predetermined operation (launch operation). The process of step S38 is performed, following step S37.

In step S38, the CPU 10 determines whether the arrow 93 has hit (contacted) another object in the game space. That is, the CPU 10 reads out the arrow data 114 from the main memory, and determines whether the arrow 93 has contacted another object. If the determination result of step S38 is affirmative, the process of step S39 is performed. On the other hand, if the determination result of step S38 is negative, the CPU 10 ends the shooting process, skipping the process of step S39.

In step S39, the CPU 10 stops the movement of the arrow 93. That is, the CPU 10 stores data which represents the position and the attitude of the arrow 93 calculated in step S37 and which indicates that the arrow 93 has stopped in the main memory as the arrow data 114. Thus, the movement of the arrow 93 is stopped in subsequent iterations of the shooting process. After the process of step S39, the CPU 10 ends the shooting process.

As described above, the CPU 10 moves an object in the game space (the arrow 93) to the specified position (the destination position of the arrow 93) in response to a predetermined launch operation (steps S37 to S39). The terminal camera moves together with the object (step S16 to be described later). Therefore, in the present embodiment, the player can place the terminal camera at an intended position by moving the terminal camera through an operation of launching the arrow 93.

In the present embodiment, when the launch operation is performed, the CPU 10 calculates the movement path (i.e., the terminal camera setting position) in advance (step S35), and then repeatedly performs the process of moving the arrow 93 (and the terminal camera) along the movement path (step S37). In other embodiments, the CPU 10 may not calculate the movement path in advance. That is, the CPU 10 may move the arrow 93 in a predetermined direction in step S35, and may successively move the arrow 93 by successively calculating the direction in which the arrow 93 should be moved based on the predetermined direction in subsequent step S37. In other embodiments, during the movement of the object which moves together with the virtual camera (herein, the arrow 93), the player may be allowed to control the movement of the object (and the virtual camera). That is, in step S37, the CPU 10 may calculate the movement direction and/or the amount of movement of the arrow 93 based on an operation by the player (operation data).

Referring back to FIG. 17, in step S15 following step S14, the CPU 10 moves the terminal camera in accordance with the movement of the arrow 93. Specifically, the position of terminal camera is set at the position of the arrow 93. The attitude (viewing direction) of the terminal camera is changed in accordance with a change in the attitude of the arrow 93. That is, the attitude of the terminal camera is changed in a direction determined in accordance with the direction in which the attitude of the arrow 93 has changed by an amount by which the attitude of the arrow 93 has changed. As a specific process of step S15, the CPU 10 reads out the arrow data 114 and the second camera data 116 from the main memory, and calculates the position and the attitude of the terminal camera. Data representing the calculated position and attitude is stored in the main memory as new second camera data 116. The process of step S16 is performed, following step S15.

As shown in step S15, in the present embodiment, the terminal camera is set at the position of the arrow 93. That is, when the destination position of the arrow 93 is specified by a launch operation (step S35), the terminal camera is set at the specified position.

In the present embodiment, when the virtual camera setting position has not been specified (i.e., when the launch operation has not been performed), the arrow 93 is set at a position that is determined in accordance with the movement of the player character 91 (step S33), and therefore the terminal camera moves in accordance with the movement of the player character 91. Then, before the launch operation is performed, the player does not need to perform the operation of moving the terminal camera, separately from the operation of moving the player character 91, thereby making game operations easier. When specifying the terminal camera setting position, the player can check the position to be specified by looking at the terminal game image. Then, the player can perform a series of operations of specifying a position in the game space and checking an image of the game space as viewed from the specified position by looking only at the game image displayed on the terminal device 7 (it is understood that the player may perform the operation while making a visual comparison with the game image displayed on the television 2). Thus, the player can more easily perform the series of operations.

In the present embodiment, in a state before the arrow 93 is launched (i.e., where the terminal camera setting position has not been specified), the arrow 93 is set at the position of the crossbow 92 (step S33) and the terminal camera is also set at the position of the crossbow 92. That is, in such a state, the terminal camera is set at a position which is the viewpoint of the player character 91. On the other hand, the television camera is set so that the player character 91 is included in the viewing field range (step S13). Therefore, in such a state, a so-called “subjective perspective” game image is displayed on the terminal device 7, and an objective perspective game image is displayed on the television 2 (FIGS. 12 and 13). Then, since the player can visually check the game space from different viewpoints, the player can easily grasp the circumstances in the game space. For example, when the terminal camera is placed at an intended position, the player can generally determine the position at which to place the terminal camera by looking at the objective perspective television game image (checking the positional relationship between the player character 91 and surrounding objects), and then precisely determine the position by looking at the subjective perspective terminal game image. Thus, displaying two game images from different viewpoints makes it easier to perform the operation of placing the terminal camera.

Since the attitude of the arrow 93 changes in accordance with the change in the direction (shooting direction) specified in step S31 (step S33), the terminal camera also changes in accordance with the change in direction. Thus, the player can simultaneously perform the operation of changing the display range of the terminal game image and the operation of changing the direction to be specified (the position at which the virtual camera is set), and it is therefore possible to easily set the terminal camera across a wide area of the game space.

In step S16, the CPU 10 changes the direction of the terminal camera in accordance with a predetermined direction-changing operation. While the direction-changing operation may be any operation as long as a direction can be input, it is a direction input operation on the analog joy stick 81 with the C button of the sub-controller 9 being pressed in the present embodiment. The CPU 10 rotates the terminal camera in a direction that is determined in accordance with the up, down, left or right direction input on the analog joy stick 81 in such a state as described above. The amount by which the terminal camera is rotated may be a predetermined fixed amount, or may be an amount that is determined in accordance with the amount by which the analog joy stick 81 is tilted. In the present embodiment, the terminal camera rotates in the pitch direction in accordance with an input in the up or down direction, rotates in the yaw direction in accordance with an input in the left or right direction, and does not rotate in the roll direction (the rotation direction about an axis extending in the viewing direction). In other embodiments, the terminal camera may be allowed to rotate in the roll direction. As a specific process of step S16, the CPU 10 reads out the second camera data 116 from the main memory, and calculates the changed attitude of the terminal camera based on the controller operation data 101 obtained in step S2 and the second camera data 116. Then, the CPU 10 updates the second camera data 116 so that it represents the changed attitude. The CPU 10 ends the game control process after step S16.

With the process of step S16, the direction of the terminal camera is changed in accordance with a direction-changing operation that is different from the operation performed on the player character 91. That is, the CPU 10 controls the direction of the terminal camera based on an operation by the player (operation data), independent of the movement of the player character 91. Therefore, the player can change the viewing direction in addition to being able to specify the position of the terminal camera, and therefore the player can more freely change the viewing direction of the terminal game image.

In the present embodiment, the process of step S16 is performed before and after specifying the position at which the terminal camera is placed (i.e., before and after performing the launch operation). That is, the player can perform the direction-changing operation described above before and after the launch operation. In other embodiments, the CPU 10 may allow the player to perform the direction-changing operation only after (or before) the launch operation.

Referring back to FIG. 16, the process of step S4 is performed, following the game control process of step S3. In step S4, the television game image, which is an objective perspective game image, is generated based on the game control process. That is, the CPU 10 and the GPU 11b read out data representing the results of the game control process of step S3 (the data 112 to 114 of various objects in the game space, the first camera data 115, etc.) from the main memory, and also read out data used for generating a game image from the VRAM 11d, to generate a television game image. In the present embodiment, the television game image is generated based on the television camera. As a result, a game image representing the game space including the player character 91 is generated as the television game image. In this process, the television game image is generated with the player character 91 being semitransparent. The generated television game image is stored in the VRAM. 11d. The process of step S5 is performed, following step S4.

In step S5, the terminal game image which is a game image as viewed from the position of the arrow 93 is generated based on the game control process. That is, the CPU 10 and the GPU 11b read out data representing the results of the game control process of step S3 from the main memory, and also read out data used for generating a game image from the VRAM 11d, to generate the terminal game image. In the present embodiment, the terminal game image is generated based on the terminal camera. As a result, a game image showing the game space as viewed from the position of the arrow 93 is generated as the terminal game image. The generated television game image is stored in the VRAM 11d. The process of step S6 is performed, following step S5.

In step S6, the CPU 10 outputs the game image to the television 2. Specifically, the CPU 10 sends data of the television game image stored in the VRAM 11d to the AV-IC 15. In response to this, the AV-IC 15 outputs the data of the television game image to the television 2 via the AV connector 16. Thus, the television game image is displayed on the television 2. In step S6, game sound data may also be output to the television 2, together with the game image data, so as to output the game sound from the speaker 2a of the television 2. The process of step S7 is performed, following step S6.

In step S7, the CPU 10 outputs the game image to the terminal device 7. Specifically, the image data of the terminal game image stored in the VRAM 11d is sent to the codec LSI 27 by the CPU 10, and is subjected to a predetermined compression process by the codec LSI 27. The compressed image data is transmitted by the terminal communication module 28 to the terminal device 7 via the antenna 29. The terminal device 7 receives, by means of the wireless module 70, the image data transmitted from the game device 3, and a predetermined expansion process is performed by the codec LSI 66 on the received image data. The expanded image data is output to the LCD 51. Thus, the terminal game image is displayed on the LCD 51. In step S7, the game sound data may also be transmitted to the terminal device 7, together with the game image data, so as to output the game sound from the speaker 67 of the terminal device 7. The process of step S8 is performed, following step S7.

In step S8, the CPU 10 determines whether the game should be ended. The determination of step S8 is made based on, for example, whether the game is over, or whether the user has given an instruction to quit the game, etc. If the determination result of step S8 is negative, the process of step S2 is performed again. If the determination result of step S8 is affirmative, the CPU 10 ends the game process shown in FIG. 16. When ending the game process, the CPU 10 may perform a process of, for example, saving game data in a memory card, or the like. Thereafter, the series of processes through steps S2 to S8 is repeatedly performed until it is determined in step S8 that the game should be ended.

With the game process described above, a game image showing the game space as viewed from the viewpoint and in the viewing direction in accordance with the movement of the player character 91 is displayed on the television 2 (FIG. 12), and a game image showing the game space as viewed from a position specified by the player is displayed on the terminal device 7 (FIG. 14). Therefore, the game device 3 can display, on two display devices, different game images showing the game space as viewed from a plurality of viewpoints. Since the position of the viewpoint for the terminal game image can be set by the player, a place that is a blind spot on the television game image can be made visible on the terminal game image, for example. Therefore, with the present embodiment, it is possible to present, to the player, easy-to-view game images with which the game space can be grasped more easily. With the present embodiment, game images showing the game space as viewed from a plurality of viewpoints can be displayed simultaneously on two display devices, and the player can therefore smoothly play the game without having to switch between game images.

[7. Variations]

The embodiment above is merely an example, and the game system, etc., may be implemented with a configuration to be described below, for example, in other embodiments.

(Variation Regarding Position Specifying Method)

In the embodiment above, the position at which the virtual camera (terminal camera) is set is specified in accordance with the attitude of the controller 5. In other embodiments, the position may be specified (determined) based on operation data. The variation regarding the position specifying method will be described below.

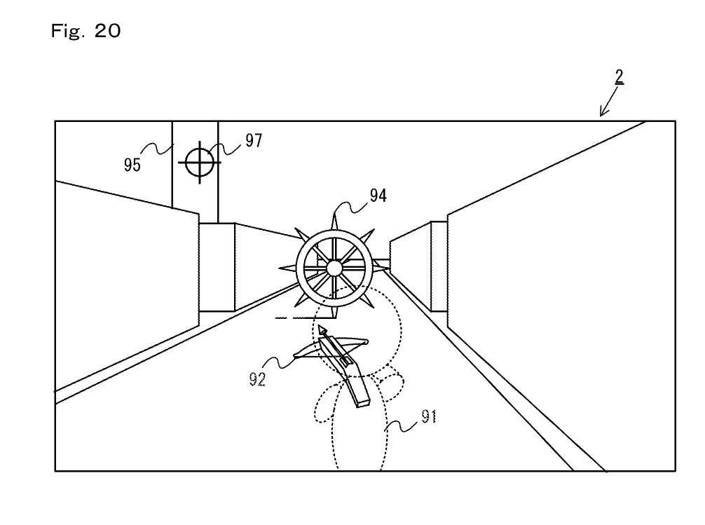

In other embodiments, the CPU 10 may calculate the position coordinates on the television game image based on operation data, and specify a position in the game space corresponding to the position coordinates. FIG. 20 is a diagram showing an example television game image in the variation of the embodiment above. The game image shown in FIG. 20 is different from the game image shown in FIG. 12 in that a cursor 97 is displayed therein. In this variation, the position of the cursor 97 is controlled in accordance with the operation by the player. Then, in response to a launch operation, the arrow 93 is launched to a position in the game space that is indicated by the cursor 97. Thus, the terminal camera setting position may be specified by using the cursor 97 which is controlled by the player.

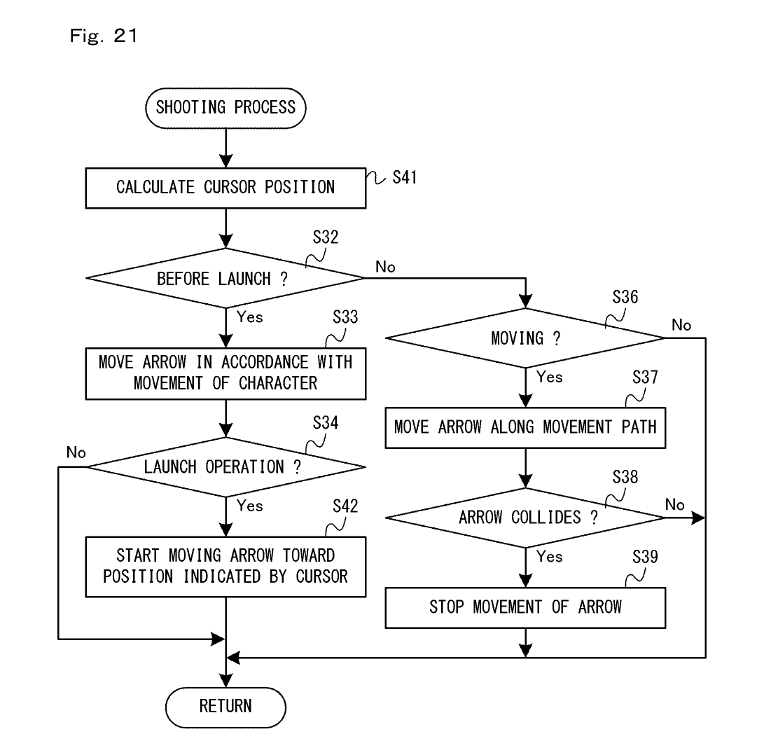

FIG. 21 is a flow chart showing the flow of a shooting process in the variation shown in FIG. 20. In FIG. 21, the same process steps as those of the shooting process shown in FIG. 19 are given the same step numbers as those of FIG. 19, and will not be described in detail.

In the shooting process of this variation, in step S41, the CPU 10 calculates the cursor position on the screen of the television 2 based on the controller operation data 101. The process of step S41 is a process of calculating the position coordinates (the coordinates of the cursor position) on the television game image based on operation data. While the cursor position may be calculated by any method, it is for example calculated in accordance with the attitude of the controller 5. Specifically, the CPU 10 sets the position at the center of the screen of the television 2 as the cursor position when the controller 5 is in a predetermined attitude (which may be the reference attitude described above). When the attitude of the controller 5 is changed from the predetermined attitude, the cursor position is moved from the center of the screen by an amount of movement that is determined in accordance with the amount by which the attitude of the controller 5 has changed. In other embodiments, the cursor position may be controlled based on a direction input on the controller 5 (e.g., a direction input on the operation button 32a of the main controller 8 or the analog joy stick 81 of the sub-controller 9). As a specific process of step S41, the CPU 10 reads out the attitude data 111 from the main memory, and calculates the cursor position based on the attitude of the controller 5. Data representing the calculated cursor position is stored in the main memory. The process of step S32 is performed, following step S41.

Also in this variation, the process of steps S32 to S34 is performed in a similar manner to that in the embodiment above. If the determination result of step S34 is affirmative, (i.e., if a launch operation has been performed), the process of step S42 is performed. In step S42, the CPU 10 starts moving the arrow 93 to a position in the game space corresponding to the cursor position. The “position in the game space corresponding to the cursor position” is a position in the game space indicated by the cursor 97. More specifically, it is a position in the game space that is hit by a straight line extending from the camera position in the cursor direction. For the movement of the arrow 93, the CPU 10 first calculates a movement path which would be obtained if the arrow 93 were moved to that position in accordance with a predetermined movement rule, and then moves the arrow 93 by a predetermined distance along the movement path. As a specific process of step S42, the CPU 10 reads out data representing the cursor position and the arrow data 114 from the main memory, and calculates the movement path. Then, the CPU 10 calculates the position and the attitude of the arrow 93 after the movement based on the movement path. Also in this variation, as in the embodiment above, data which represents the position and the attitude of the arrow 93 after the movement and which indicates that the arrow 93 is moving is stored in the main memory as the arrow data 114. The CPU 10 ends the shooting process after step S42.

The process of step S42 specifies a position in the game space that corresponds to the position coordinates calculated in step S41. Then, the process of steps S36 to S39 and S15, which is performed also in this variation as in the embodiment above, sets the television camera at the specified position. Thus, the terminal camera is set at the position indicated by the cursor 97. In step S4, a game image is generated in which the cursor 97 is rendered on an image showing game space as viewed from the television camera.

In the variation above, the position and the attitude of the television camera may be changed in accordance with the position of the cursor 97. For example, when the cursor 97 moves near an end portion of the screen, the CPU 10 may rotate the television camera toward the end portion near which the cursor 97 has moved. Then, the player can change the viewing direction of the television camera by an operation of moving the cursor, and the player can therefore easily specify positions, with the cursor 97, across a wider area of the game space. In this case, the CPU 10 may change the attitude of the terminal camera (viewing direction) in accordance with the position specified by the cursor 97. That is, the terminal camera may be controlled so as to be directed toward the position specified by the cursor 97. The CPU 10 may change the posture of the player character 91 (the attitude of the crossbow 92) in accordance with the position of the cursor 97 so that the crossbow 92 is directed toward the position indicated by the cursor 97.

With the variation above, the cursor 97 is displayed on the television 2, and the player can specify a position using the cursor 97. Therefore, the player can perform the operation on the player character 91 and the operation of specifying the position at which the terminal camera is placed, both looking at the screen of the television 2.

While the game device displays the cursor 97 on the television 2 in the variation above, it may display a cursor on the terminal device 7 in other embodiments. That is, the CPU 10 may calculate position coordinates on the terminal game image based on operation data, and specify a position in the game space that corresponds to the position coordinates. Since the operation is easier when the controller 5 (the main controller 8) is used while being directed toward the terminal device 7, the marker unit 55 of the terminal device 7 may be used as the marker instead of the marker device 6 placed around the television 2. That is, the CPU 10 may light the marker unit 55 instead of the marker device 6. As in the variation above, the CPU 10 may change the position and the attitude of the terminal camera in accordance with the position of the cursor 97, and the CPU 10 may change the posture of the player character 91 (the attitude of the crossbow 92) in accordance with the position of the cursor 97.

Where the cursor is displayed on the terminal device 7 as described above, the player can easily perform a series of operations of specifying a position in the game space and checking the image of the game space as viewed from the specified position, by looking only at the terminal device 7, as in the embodiment above.

In other embodiments, the position at which the terminal camera is set may be specified by using the touch panel 52 of the terminal device 7. That is, the CPU 10 may calculate position coordinates at which an input is made on the touch panel 52, and specify a position in the game space that corresponds to the position coordinates. Where a position is specified by the touch panel 52, since the shooting direction is not determined until an input is made on the touch panel 52, it is not possible to change the attitude of the crossbow 92 and the arrow 93 in accordance with the shooting direction. Therefore, when there is an input on the touch panel 52, the CPU 10 may first change the attitude of the crossbow 92 and the arrow 93 and then launch the arrow 93.

(Variation Regarding Game Images)

In the embodiment above, the game device 3 displays a subjective perspective game image and an objective perspective game image on two display devices (the television 2 and the terminal device 7) in order to make it easier for the player to grasp the game space and perform game operations. In other embodiments, the game device 3 may display two game images as viewed from the same viewpoint on different display devices. Also in this case, it is possible to present game images with which it is easily to grasp the game space by using different viewing directions for the game images. It is possible to present game images which make it easier to grasp the game space and perform operations by, for example, allowing the player to change the viewing direction of each game image, or by controlling the viewing direction of one game image to be the direction of the player character 91 while controlling the viewing direction of the other game image to be the shooting direction. While the two game images may each be in subjective perspective or in objective perspective as described above, it is believed that operations are easier with a subjective perspective game image when a shooting operation (a position-specifying operation) is performed, and therefore a subjective perspective game image may be displayed at least on either display device when the player is allowed to perform the shooting operation (when the shooting operation is possible).

In the embodiment above, before the terminal camera is placed at the position specified by the player, the terminal camera is placed at the position of the player character 91 (the position of the arrow 93), and the terminal game image is generated using the terminal camera. In other embodiments, the terminal game image under such circumstances may be any image. The terminal game image under such circumstances may be a menu image for selecting an item, a map image, or a game image representing the game space as viewed from a predetermined viewpoint. For example, in other embodiments, the player character 91 may be allowed to use a plurality of different items including the crossbow 92, and a menu image for selecting an item may be displayed on the terminal device 7. In this case, if the crossbow 92 is selected in the menu image, the CPU 10 may make the player character 91 hold the crossbow 92, and display a game image representing the game space as viewed from the arrow 93 (FIG. 13) on the terminal device 7. In other embodiments, the terminal game image under such circumstances may be a game title image, or no game image may be displayed on the terminal device 7 under such circumstances.

In the embodiment above, the player is allowed to freely set the viewpoint of the game image to be displayed on the terminal device 7 by placing the terminal camera at a position specified by the player. In other embodiments, the CPU 10 may place the television camera at the position specified by the player. Then, the terminal camera is controlled in accordance with the movement of the player character 91, as with the television camera in the embodiment above. In other embodiments, two game images displayed on the television 2 and the terminal device 7 may be switched from one to another in response to an operation by the player or in response to satisfaction of a predetermined game condition. The predetermined game condition may be any condition as long as it is a condition related to the game, and may be, for example, that the player character has advanced to a predetermined stage, or that the position of a predetermined object has been specified as the virtual camera setting position. For example, where an objective perspective game image is displayed on the television 2 and a subjective perspective game image on the terminal device 7, in response to the player specifying a predetermined position in the game space, the CPU 10 may display a game image as viewed from the specified position on the television 2 and display an objective perspective game image (which was displayed on the television 2) on the terminal device 7.

While only one position can be specified as the position at which the virtual camera is placed in the embodiment above, a plurality of positions in the game space may be allowed to be specified, with the CPU 10 setting virtual cameras at the specified positions, in other embodiments. Then, a plurality of game images representing the game space as viewed from the virtual cameras which have been set on the display device (the television 2 or the terminal device 7). That is, the display area of the display device is split, and a game image of the game space as viewed from a different virtual camera is displayed in each split display area. For example, in the embodiment above, the player character 91 may be allowed to launch a plurality of arrows, and images of the game space as viewed from the positions of the arrows may be displayed on the terminal device 7 (or the television 2).

(Variation Regarding Controller Device)

In the embodiment above, the operation unit used by the player is the controller 5. In other embodiments, the terminal device 7 may be used as an operation unit. That is, while the operation unit is provided in a separate casing (the housings 31 and 80) from the two display devices in the embodiment above, the operation unit may be provided in one of the display devices in other embodiments. Where the player performs game operations using the terminal device 7, the terminal device 7 is in the hands of the player with the television 2 arranged far in front of the player. Then, the player will vary the viewing direction substantially when looking at the television 2 and when looking at the terminal device 7. Therefore, in a game that assumes such a control mode that the player performs game operations while frequently switching their eyes back and forth between the television 2 and the terminal device 7, it is advantageous to have an operation unit provided in a separate casing from the two display devices, thereby making it easier to view the game images.

(Variation Regarding how to Set Terminal Camera)

In the embodiment above, before the camera setting position is specified by the player, the terminal camera is placed at the position of the player character 91 (more specifically, the position of the arrow 93). In other embodiments, under such circumstances, the terminal camera may be set at a position that views the player character 91 in objective perspective, other than at the position of the player character 91. Under such circumstances, the terminal camera may be controlled so as to move in accordance with the movement of the player character 91 or may be set in a fixed manner at a predetermined position in the game space.

While the terminal camera is controlled to move together with the arrow 93 in the embodiment above, the terminal camera does not need to be controlled so as to move together with another object. For example, in other embodiments, the terminal camera may be set at the position of the crossbow 92 while the arrow 93 is moving, and the terminal camera may be set at the position of the arrow 93 in response to the arrow 93 sticking in another object.

In other embodiments, when the virtual camera is set at a position specified by the player, the CPU 10 may control the virtual camera (automatically even when there is no operation by the player) so as to assume an attitude such that the predetermined object (e.g., the player character 91) is included in the viewing field range. For example, in the embodiment above, if the movement of the arrow 93 is stopped by the process of step S39, the CPU 10, in step S15, sets the position of terminal camera at the position of the arrow 93 and sets the attitude of the terminal camera so that the viewing direction is toward the player character 91. Then, data representing the set position and attitude is stored in the main memory as the second camera data 116. Then, the player can visually check the game space as viewed from the specified position looking in the direction of the player character 91 without performing an operation of changing the direction of the terminal camera (the direction-changing operation described above).

(Variation Regarding Contents of Game)

While a shooting game in which the player character 91 launches the arrow 93 is described in the embodiment above, the contents of the game may by of any kind in other embodiments, and are not limited to shooting games. The game system. 1 is applicable to any game in which the player controls the player character 91 in a virtual game space.

(Variation Regarding Configuration of Game System)

In the embodiment above, the game system 1 has a configuration including the portable terminal device 7 and the television 2 as display devices. Herein, the game system may have any configuration as long as different game images can be output to and displayed on two display devices. For example, in other embodiments, the game system may have a configuration in which the terminal device 7 is absent and two televisions are used as display devices, or a configuration in which two terminal devices 7 are used as display devices.

(Variation Regarding Information Processing Device Performing Game Process)

While a series of game processes of the game system 1 is performed by the game device 3 in the embodiment above, some of the game processes may be performed by another device. For example, in other embodiments, some of the game processes (e.g., the process of generating the terminal game image) may be performed by the terminal device 7. In other embodiments, in a game system that includes a plurality of information processing devices that can communicate with each other, the game processes may be divided among the plurality of information processing devices. Where game processes are performed by a plurality of information processing devices, the game processes will be complicated because game processes to be performed by different information processing devices are synchronized together. In contrast, where game processes are performed by a single game device 3, wherein the terminal device 7 is responsible for the process of receiving and displaying game images, as in the present embodiment (i.e., where the terminal device 7 is a thin client terminal), there is no need to synchronize the game processes between a plurality of information processing devices, and it is therefore possible to simplify the game processes.

As discussed above, the various systems, methods, and techniques described herein may be implemented in digital electronic circuitry, computer hardware, firmware, software, or in combinations of these elements. Apparatus embodying these techniques may include appropriate input and output devices, a computer processor, and a computer program product tangibly embodied in a non-transitory machine-readable storage device for execution by a programmable processor. A process embodying these techniques may be performed by a programmable processor executing a suitable program of instructions to perform desired functions by operating on input data and generating appropriate output. The techniques may be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language, if desired; and in any case, the language may be a compiled or interpreted language. Suitable processors include, by way of example, both general and special purpose microprocessors. Generally, a processor will receive instructions and data from a read-only memory and/or a random access memory. Non-transitory storage devices suitable for tangibly embodying computer program instructions and data include all forms of computer memory including, but not limited to, (a) non-volatile memory, including by way of example semiconductor memory devices, such as Erasable Programmable Read-Only Memory (EPROM), Electrically Erasable Programmable Read-Only Memory (EEPROM), and flash memory devices; (b) magnetic disks such as internal hard disks and removable disks; (c) magneto-optical disks; and (d) Compact Disc Read-Only Memory (CD-ROM). Any of the foregoing may be supplemented by, or incorporated in, specially-designed ASICs (application-specific integrated circuits).

The processing system/circuitry described in this specification is “programmed” to control processes such as game processes in accordance with the “logic” described in the specification. A processing system including at least one CPU when executing instructions in accordance this logic may operate as “programmed logic circuitry” to perform the operations defined by the logic.

The systems, devices and apparatuses described herein may include one or more processors, which may be located in one place or distributed in a variety of places communicating via one or more networks. Such processor(s) can, for example, use conventional 3D graphics transformations, virtual camera and other techniques to provide appropriate images for display. By way of example and without limitation, the processors can be any of: a processor that is part of or is a separate component co-located with the stationary display and which communicates remotely (e.g., wirelessly) with the movable display; or a processor that is part of or is a separate component co-located with the movable display and communicates remotely (e.g., wirelessly) with the stationary display or associated equipment; or a distributed processing arrangement some of which is contained within the movable display housing and some of which is co-located with the stationary display, the distributed portions communicating together via a connection such as a wireless or wired network; or a processor(s) located remotely (e.g., in the cloud) from both the stationary and movable displays and communicating with each of them via one or more network connections; or any combination or variation of the above.

The processors can be implemented using one or more general-purpose processors, one or more specialized graphics processors, or combinations of these. These may be supplemented by specifically-designed ASICs (application specific integrated circuits) and/or logic circuitry. In the case of a distributed processor architecture or arrangement, appropriate data exchange and transmission protocols are used to provide low latency and maintain interactivity, as will be understood by those skilled in the art.

Similarly, program instructions, data and other information for implementing the systems and methods described herein may be stored in one or more on-board and/or removable memory devices. Multiple memory devices may be part of the same device or different devices, which are co-located or remotely located with respect to each other.

As described above, the present embodiment is applicable to, for example, a game device, a game program, or a game system, with the aim of making it possible to display game images showing the game space as viewed from a plurality of viewpoints, and to present, to the player, game images that are easier to view.

While certain example systems, methods, devices and apparatuses have been described herein, it is to be understood that the appended claims are not to be limited to the systems, methods, devices and apparatuses disclosed, but on the contrary, are intended to cover various modifications and equivalent arrangements included within the spirit and scope of the appended claims.

1. A game device for performing a game process based on operation data which is based on an operation performed on an operation unit, the game device comprising:
an operation data obtaining unit for obtaining the operation data;
a character control unit for controlling an action of a character in a virtual space based on the operation data;
a first camera control unit for controlling a first virtual camera in the virtual space in accordance with movement of the character;
a first image generation unit for generating a first game image based on the first virtual camera;
a position specification unit for specifying a position in the virtual space based on the operation data;
a second camera control unit for Setting a second virtual camera at the position specified by the position specification unit;
a second image generation unit for generating a second game image based on the second virtual camera; and
an image output unit for outputting the first game image to a first display device and the second game image to a second display device.

2. The game device according to claim 1, wherein the second camera control unit moves the second virtual camera in accordance with the movement of the character when no position is specified by the position specification unit.

3. The game device according to claim 2, wherein:
the first camera control unit sets the first virtual camera so that the character is included in a viewing field range; and
the second camera control unit sets the second virtual camera at a position which is a viewpoint of the character when no position is specified by the position specification unit.

4. The game device according to claim 1, wherein the second camera control unit further controls a direction of the second virtual camera based on the operation data, independent of the movement of the character.

5. The game device according to claim 1, wherein the position specification unit specifies a direction in the virtual space based on the operation data, thereby specifying a position that is determined by the specified direction.

6. The game device according to claim 5, wherein the second camera control unit changes a direction of the second virtual camera in accordance with a change in the specified direction.

7. The game device according to claim 1, wherein the position specification unit calculates position coordinates on the first game image based on the operation data, thereby specifying a position in the virtual space corresponding to the position coordinates.

8. The game device according to claim 1, wherein the position specification unit calculates position coordinates on the second game image based on the operation data, thereby specifying a position in the virtual space corresponding to the position coordinates.

9. The game device according to claim 1, wherein:
the operation data includes data representing a physical quantity for calculating an attitude of the operation unit;
the game device further includes an attitude calculation unit for calculating an attitude of the operation unit based on the physical quantity; and
the position specification unit calculates the specified position so that the specified position changes in accordance with a change in the attitude of the operation unit.

10. The game device according to claim 9, wherein:
the operation unit includes a gyrosensor; and
the operation data includes, as the physical quantity, data representing an angular velocity detected by the gyrosensor.

11. The game device according to claim 1, further comprising an object control unit for moving a predetermined object in the virtual space to the specified position in response to a predetermined operation,
wherein the second camera control unit moves the second virtual camera together with the predetermined object.

12. The game device according to claim 1, wherein the operation unit is provided in a holdable housing separate from the first display device and the second display device.

13. The game device according to claim 1, wherein the operation unit is provided in the second display device.

14. A game system comprising the game device according to claim 1, the operation unit, and the second display device, wherein:
the second display device is a portable display device;
the image output unit includes an image transmitting unit for wirelessly transmitting the second game image to the second display device; and
the second display device includes:
an image receiving unit for receiving the second game image; and
a display unit for displaying the second game image received by the image receiving unit.

15. A non-transitory computer-readable storage medium storing a game program to be executed by a computer of a game device for performing a game process based on operation data which is based on an operation performed on an operation unit, the game program causing the computer to execute:
obtaining the operation data;
controlling an action of a character in a virtual space based on the operation data;
controlling a first virtual camera in the virtual space in accordance with movement of the character;
generating a first game image to be displayed on a first display device based on the first virtual camera;
specifying a position in the virtual space based on the operation data;
setting a second virtual camera at a position specified by the position specification unit; and
generating a second game image to be displayed on a second display device based on the second virtual camera.

16. The non-transitory storage medium according to claim 15, wherein the second virtual camera is moved in accordance with the movement of the character when no position is specified by the position specification unit.

17. The non-transitory storage medium according to claim 16, wherein:
the first virtual camera is set so that the character is included in a viewing field range; and
the second virtual camera is set at a position which is a viewpoint of the character when no position is specified by the position specification unit.

18. The non-transitory storage medium according to claim 15, wherein a direction of the second virtual camera is further controlled based on the operation data, independent of the movement of the character.

19. The non-transitory storage medium according to claim 15, wherein the specified position in the virtual space is determined by a direction in the virtual space specified based on the operation data.

20. The non-transitory storage medium according to claim 19, wherein a direction of the second virtual camera is changed in accordance with a change in the specified direction.

21. The non-transitory storage medium according to claim 15, wherein the specified position in the virtual space corresponds to position coordinates on the first game image, the position coordinates being calculated based on the operation data.

22. The non-transitory storage medium according to claim 15, wherein the specified position in the virtual space corresponds to position coordinates on the second game image, the position coordinates being calculated based on the operation data.

23. The non-transitory storage medium according to claim 15, wherein:
the operation data includes data representing a physical quantity for calculating an attitude of the operation unit;
the game program causes the computer to further execute obtaining an attitude of the operation unit calculated based on the physical quantity; and
the specified position is calculated so that the specified position changes in accordance with a change in the attitude of the operation unit.

24. The non-transitory storage medium according to claim 23, wherein:
the operation unit includes a gyrosensor; and
the operation data includes, as the physical quantity, data representing an angular velocity detected by the gyrosensor.

25. The non-transitory computer-readable storage medium according to claim 15, wherein:
the game program causes the computer to further execute moving a predetermined object in the virtual space to the specified position in response to a predetermined operation; and
the second virtual camera is moved together with the predetermined object.

26. The non-transitory storage medium according to claim 15, wherein the operation data is obtained from an operation unit provided in a holdable housing separate from the first display device and the second display device.

27. The non-transitory storage medium according to claim 15, wherein the operation data is obtained from an operation unit provided in the second display device.

28. A game process method to be carried out by a game device for performing a game process based on operation data which is based on an operation performed on an operation unit,
the game device:
obtaining the operation data;
controlling an action of a character in a virtual space based on the operation data;
controlling a first virtual camera in the virtual space in accordance with movement of the character;
generating a first game image based on the first virtual camera;
specifying a position in the virtual space based on the operation data;
setting a second virtual camera at the position specified in the position specification step;
generating a second game image based on the second virtual camera; and
outputting the first game image to a first display device and the second game image to a second display device.

29. The game process method according to claim 28, wherein the game device moves the second virtual camera in accordance with movement of the character when no position is specified by the position specification step.

30. The game process method according to claim 28, wherein the game device further controls a direction of the second virtual camera based on the operation data, independent of the movement of the character.
